(19) United States
(12) Patent Application Publication
(10) Pub. No.: US 2026/0110808 A1
(43) Pub. Date: Apr. 23, 2026

(54) LARGE BENDABLE RADIATION DETECTOR

(71) Applicant: DRTECH CORPORATION, Seongnam-si Gyeonggi-do (KR)

(72) Inventors: Beom Jin MOON, Suwon-si Gyeonggi-do (KR); Hyeong Sik KIM, Hwaseong-si Gyeonggi-do (KR); Hyun Sup SHIM, Anyang-si Gyeonggi-do (KR); Yong Cheol GIL, Suwon-si Gyeonggi-do (KR); Ki Beom KIM, Seongnam-si Gyeonggi-do (KR)

(73) Assignee: DRTECH CORPORATION, Seongnam-si Gyeonggi-do (KR)

(21) Appl. No.: 19/423,979

(22) Filed: Dec. 17, 2025

Related U.S. Application Data
(63) Continuation of application No. PCT/KR2024/008651, filed on Jun. 21, 2024.

(30) Foreign Application Priority Data
Jun. 21, 2023 (KR) 10-2023-0079956
Jun. 21, 2023 (KR) 10-2023-0079960
Jun. 21, 2023 (KR) 10-2023-0079962

(51) Int. Cl. G01T 1/20; G01N 23/04; G01T 1/24

(52) U.S. Cl. CPC G01T 1/20; G01N 23/04; G01T 1/24

(57) ABSTRACT

The present disclosure relates to a radiation detector for detecting radiation, wherein the radiation detector comprises: a first radiation detection panel, which is flexible, extending in a first direction and detecting radiation incident on a front surface; a second radiation detection panel, which is flexible, extending in the first direction and detecting radiation incident on a front surface, wherein at least a portion of a rear surface of the first radiation detection panel overlaps at least a portion of a front surface of the second radiation detection panel; and a main plate, which is plate-shaped, located at rear surfaces of the first radiation detection panel and the second radiation detection panel and supporting at least a portion of the first radiation detection panel and the second radiation detection panel.

### CROSS-REFERENCE TO RELATED APPLICATIONS

This application is a continuation of International Application No. PCT/KR2024/008651 filed on Jun. 21, 2024, which claims priority to Korean Patent Applications No. 10-2023-0079956, No. 10-2023-0079960, and No. 10-2023-0079962 filed on Jun. 21, 2023, the entire contents of which are herein incorporated by reference.

### TECHNICAL FIELD

The present disclosure describes a large bendable radiation detector. More specifically, the present disclosure relates to a structure and a manufacturing method of the large bendable radiation detector. In addition, the present disclosure discloses a bendable radiation detector couplable to an object. More specifically, the present disclosure relates to a radiation detector coupled to the object by using a fixing band. In addition, the present disclosure describes a small bendable radiation detector. More specifically, the present disclosure relates to a structure and a manufacturing method of the small bendable radiation detector.

### BACKGROUND ART

The present disclosure relates to a mechanical structure of a large bendable radiation detector for imaging a large-diameter pipe mainly installed in pipeline transportation. The large-diameter pipe refers to a pipe having a diameter of about 15 inches or more and is used as an oil pipeline for transporting gas or oil, a water and sewage pipe, and the like. The reason for inspecting these pipes is to compensate for and deal with cases where wear or damage occurs at joint portions of the pipes depending on the substance transported by each pipe. A large bendable radiation detector may be required to image the large-diameter pipe. As the detector becomes larger, the detector must withstand a large physical force, and thus, for stable operation of the radiation detector, the radiation detector may have a mechanical structure capable of overcoming an applied force.

A small bendable radiation detector may be required to image a small-diameter pipe. The small bendable detector may be widely used in the shipbuilding industry. In the case of the bendable radiation detector, a mechanical structure for maintaining a curved shape may be required. Unlike a flat panel radiation detector, the bendable radiation detector designed to reduce distortion of the pipe may have a mechanical structure for maintaining curvature and a mechanical structure for preventing excessive curvature from being formed.

In order for the bendable radiation detector to image the object, the bendable radiation detector may need to be easily fixed to the object. The present disclosure may include a structure for securely fixing the bendable radiation detector to the pipe. Usability and convenience of the radiation detector may be improved by a detachable fixing structure.

Commercialized bendable radiation detectors are most widely used in the pipeline transportation industry that transports gas or oil. In order to use the bendable radiation detector in close contact with the pipe in these industrial sites, a method of fixing the bendable radiation detector to the pipe is required, but in the case of a non-magnetic steel pipe, a magnet cannot be used, and thus the bendable radiation detector must be fixed by using a physical method. However, when the bendable radiation detector is fixed to the pipe by using the physical method, the radiation detector or the object may be damaged, and thus a method for compensating for this is required.

### SUMMARY

### [Technical Problem]

The present disclosure relates to a structure of a stable large bendable radiation detector. In addition, the present disclosure relates to a mechanical structure for maintaining bending of a small bendable radiation detector. In addition, the present disclosure relates to a mechanical structure for securely fixing a bendable radiation detector to a pipe.

### [Technical Solution]

A radiation detector for detecting radiation according to the present disclosure comprises: a first radiation detection panel, which is flexible, extending in a first direction and detecting radiation incident on a front surface; a second radiation detection panel, which is flexible, extending in the first direction and detecting radiation incident on a front surface, wherein at least a portion of a rear surface of the first radiation detection panel overlaps at least a portion of a front surface of the second radiation detection panel; and a main plate, which is plate-shaped, located at rear surfaces of the first radiation detection panel and the second radiation detection panel and supporting at least a portion of the first radiation detection panel and the second radiation detection panel.

In the radiation detector according to the present disclosure, at least a portion of the rear surface of the first radiation detection panel is adhered to at least a portion of the front surface of the second radiation detection panel with a first adhesive, and at least a portion of the rear surface of the second radiation detection panel is adhered to at least a portion of the main plate with a second adhesive.

In the radiation detector according to the present disclosure, at least a portion of the rear surface of the first radiation detection panel is adhered to at least a portion of the front surface of the second radiation detection panel in a first adhesive region, and at least a portion of the rear surface of the second radiation detection panel is adhered to at least a portion of the main plate in a second adhesive region.

In the radiation detector according to the present disclosure, the first adhesive region and the second adhesive region are identical, and the radiation detector further comprises a fixing bracket, which is non-bendable, fixed to a rear surface of the main plate and supporting at least a portion of the first adhesive region and the second adhesive region where the first radiation detection panel and the second radiation detection panel overlap.

In the radiation detector according to the present disclosure, the first adhesive region is an overlapping region of one side of the first radiation detection panel and the other side of the second radiation detection panel, and the second adhesive region is formed on one of the other side of the first radiation detection panel or one side of the second radiation detection panel.

In the radiation detector according to the present disclosure, the main plate comprises a first cable penetration hole on the other side and a second cable penetration hole on the one side, and the radiation detector further comprises: a first circuit case coupled to a rear surface of the main plate and comprising a first circuit unit for being electrically connected to the first radiation detection panel; a second circuit case coupled to the rear surface of the main plate and comprising a second circuit unit for being electrically connected to the second radiation detection panel; a first flexible film passing through the first cable penetration hole and electrically connecting the first circuit case and the first radiation detection panel; and a second flexible film passing through the second cable penetration hole and electrically connecting the second circuit case and the second radiation detection panel.

In the radiation detector according to the present disclosure, at least one of the first circuit case and the second circuit case comprises a protruding coupling part extending in a direction opposite to the first direction, and a bolt is coupled to the protruding coupling part by passing through an elongated hole extending in the first direction formed in the main plate, such that the at least one of the first circuit case and the second circuit case is fixed to the main plate.

In the radiation detector according to the present disclosure, the second adhesive region is formed on the other side of the first radiation detection panel, and one side of the rear surface of the second radiation detection panel is adhered to at least a portion of a front surface of the second circuit case in a third adhesive region.

In the radiation detector according to the present disclosure, a width of the first cable penetration hole is smaller than a width of the second cable penetration hole.

In the radiation detector according to the present disclosure, the first radiation detection panel comprises at least one of a first sub-plate or a first shielding sheet on a rear surface of the first radiation detection panel, and the second radiation detection panel comprises at least one of a second sub-plate or a second shielding sheet on a rear surface of the second radiation detection panel.

The radiation detector according to the present disclosure further comprises a bending support part located at a rear surface of the main plate and supporting a panel assembly comprising the first radiation detection panel, the second radiation detection panel, and the main plate, wherein the bending support part comprises: a first support bracket for supporting one side of the panel assembly; a first hinge for connecting the first support bracket and a first connection bracket; the first connection bracket coupled to the first hinge and being extendable and retractable; a second hinge for connecting the first connection bracket and a base bracket; the base bracket for supporting a center of the panel assembly; a third hinge for connecting the base bracket and a second connection bracket; the second connection bracket coupled to the third hinge and being extendable and retractable; a fourth hinge for connecting the second connection bracket and a second support bracket; and the second support bracket coupled to the fourth hinge and supporting the other side of the panel assembly.

The radiation detector according to the present disclosure further comprises a bending support part located at a rear surface of the main plate and supporting a panel assembly comprising the first radiation detection panel, the second radiation detection panel, and the main plate, wherein the bending support part comprises: a first support bracket for supporting one side of the panel assembly; a first connection bracket coupled to the first support bracket; a central hinge for connecting the first connection bracket and a second connection bracket; a base bracket located in front of the central hinge and supporting a center of the panel assembly; the second connection bracket coupled to a second support bracket; the second support bracket for supporting the other side of the panel assembly, wherein the other side of a front surface of the first support bracket is formed with a first inclined part, one side of a front surface of the second support bracket is formed with a second inclined part, a third inclined part and a fourth inclined part are formed on the other side and the one side of a rear surface of the base bracket, respectively, and the first inclined part, the second inclined part, the third inclined part, and the fourth inclined part determine a maximum curvature of the panel assembly.

In the radiation detector according to the present disclosure, the first radiation detection panel comprises: a first TFT panel comprising a first active region in at least a portion of the first TFT panel; and a first scintillator receiving radiation and emitting visible light, and one side of the first scintillator is located in a direction opposite to the first direction relative to one side of the first active region; the second radiation detection panel comprises: a second TFT panel comprising a second active region in at least a portion of the second TFT panel; and a second scintillator receiving radiation and emitting visible light, and the other side of the second scintillator is located in the first direction relative to the other side of the second active region; and the first active region and the second active region overlap, or a line connecting the one side of the first active region and the other side of the second active region is parallel to a third direction.

In the radiation detector according to the present disclosure, an end portion of the one side of the first scintillator and an end portion of the other side of the second scintillator are in contact with each other.

In the radiation detector according to the present disclosure, the first TFT panel is located in the third direction with respect to the first scintillator, and the second TFT panel is located in a direction opposite to the third direction with respect to the second scintillator.

In the radiation detector according to the present disclosure, at least a portion of a surface of the first scintillator in the direction opposite to the third direction is in contact with at least a portion of the second active region, and at least a portion of a surface of the second scintillator in the third direction is in contact with at least a portion of the first active region.

A radiation detector for detecting radiation according to the present disclosure comprises: a first radiation detection panel, which is flexible, extending in a first direction and detecting radiation incident on a front surface; and a second radiation detection panel, which is flexible, extending in the first direction and detecting radiation incident on a front surface, wherein at least a portion of a rear surface of the first radiation detection panel overlaps at least a portion of a front surface of the second radiation detection panel, wherein: the first radiation detection panel comprises a first TFT panel comprising a first active region in at least a portion of the first TFT panel; the second radiation detection panel comprises a second TFT panel comprising a second active region in at least a portion of the second TFT panel; and the first active region and the second active region overlap, or a line connecting one side of the first active region and the other side of the second active region is parallel to a third direction.

In the radiation detector according to the present disclosure, wherein: the first radiation detection panel comprises a first scintillator receiving radiation and emitting visible light, and one side of the first scintillator is located in a direction opposite to the first direction relative to one side of the first active region; the second radiation detection panel comprises a second scintillator receiving radiation and emitting visible light, and the other side of the second scintillator is located in the first direction relative to the other side of the second active region; the first TFT panel is located in the third direction with respect to the first scintillator; and the second TFT panel is located in a direction opposite to the third direction with respect to the second scintillator.

The radiation detector according to the present disclosure further comprises a common scintillator located between the first radiation detection panel and the second radiation detection panel, wherein the first TFT panel is located in the third direction with respect to the common scintillator, and the second TFT panel is located in a direction opposite to the third direction with respect to the common scintillator.

A radiation detector for detecting radiation according to the present disclosure comprises: a flexible radiation detection panel extending in a first direction and detecting radiation incident on a first surface; a bending support part coupled to the radiation detection panel and supporting the radiation detection panel, and adjusting bending of the radiation detection panel about at least one bending axis parallel to a second direction; and a detector fixing assembly detachably coupled to the bending support part and comprising a roller contacting a fixing band for coupling the radiation detector and an object or contacting the object.

In the radiation detector according to the present disclosure, the detector fixing assembly comprises: a detector fixing frame forming a skeleton of the detector fixing assembly and coupled to the bending support part; an assembly bracket located in at least one of an upward direction or a downward direction of the detector fixing frame and comprising a friction pad on a front surface thereof for increasing friction with the object; the roller coupled to one side and the other side of the detector fixing frame and assisting rotation of the fixing band with respect to the detector fixing assembly; and a handle part coupled to a rear surface of the detector fixing frame, and a front surface of the friction pad is on the same plane as a front surface of the radiation detection panel, or protrudes in a forward direction from the front surface of the radiation detection panel.

In the radiation detector according to the present disclosure, the detector fixing assembly comprises: an upper assembly bracket contacting an upper side of the bending support part; a lower assembly bracket contacting a lower side of the bending support part; a first fixing arm, one side of which is rotatably coupled to the upper assembly bracket about a bracket axis extending parallel to the second direction, comprising a wheel axis extending parallel to the second direction for allowing the roller to rotate, and comprising a band axis on the other side thereof, to which the fixing band is coupled or which contacts a surface of the fixing band; a second fixing arm, one side of which is rotatably coupled to the lower assembly bracket about a bracket axis extending parallel to the second direction, comprising a wheel axis extending parallel to the second direction for allowing the roller to rotate, and comprising a band axis on the other side thereof, to which the fixing band is coupled or which contacts a surface of the fixing band; and a handle connecting the upper assembly bracket and the lower assembly bracket.

In the radiation detector according to the present disclosure, the detector fixing assembly comprises: a detector fixing frame forming a skeleton of the detector fixing assembly and coupled to the bending support part; a bracket axis coupled to the detector fixing frame and extending parallel to the second direction; a fixing arm, one side of which is rotatably coupled to the bracket axis, comprising a wheel axis extending parallel to the second direction for allowing the roller to rotate, and comprising a band axis on the other side thereof, to which the fixing band is coupled or which contacts a surface of the fixing band; and a handle part coupled to a rear surface of the detector fixing frame.

In the radiation detector according to the present disclosure, the fixing arm comprises: a base fixing arm rotatably coupled to the bracket axis; and an extension fixing arm rotatably coupled to the base fixing arm about the wheel axis and comprising a band axis on the other side thereof, to which the fixing band is coupled or which contacts a surface of the fixing band.

In the radiation detector according to the present disclosure, the detector fixing assembly comprises: an upper assembly bracket contacting an upper side of the bending support part and comprising a friction pad on a front surface thereof for increasing friction with the object; a lower assembly bracket contacting a lower side of the bending support part and comprising a friction pad on a front surface thereof for increasing friction with the object; a roller contacting an outer circumferential surface of the object, being rotatable about an axis parallel to the second direction, and coupled to at least one of the upper assembly bracket and the lower assembly bracket; and a handle connecting the upper assembly bracket and the lower assembly bracket.

In the radiation detector according to the present disclosure, the detector fixing assembly further comprises a strap bracket for connecting the fixing band to one side and the other side of at least one of the upper assembly bracket and the lower assembly bracket, and the strap bracket is rotatable about an axis extending parallel to the second direction, and is fixed in a predetermined position by a strap bracket fixing part.

In the radiation detector according to the present disclosure, the detector fixing assembly comprises: a detector fixing frame forming a skeleton of the detector fixing assembly and coupled to the bending support part; a bracket axis coupled to the detector fixing frame and extending parallel to the second direction; and a fixing arm, one side of which is rotatably coupled to the bracket axis, and comprising at least one band axis on the other side thereof, to which the fixing band is coupled or which contacts a surface of the fixing band, and an extension direction of the fixing arm and an extension direction of the band axis are perpendicular to each other, a fixing protrusion is formed on a lower side of the fixing arm, a fixing groove is formed on an upper side of the detector fixing frame, and the fixing arm is fixed to the detector fixing frame by coupling of the fixing protrusion and the fixing groove.

A radiation detector for detecting radiation according to the present disclosure comprises: a flexible panel assembly extending in a first direction and detecting radiation incident on a first surface; a bending support part coupled to the panel assembly and supporting the panel assembly, and adjusting bending of the panel assembly about at least one bending axis parallel to a second direction; and a plurality of band axes coupled to an upward direction and a downward direction of the bending support part, and the band axes are coupled to the bending support part at predetermined intervals along a longitudinal direction of the bending support part.

A radiation detector for detecting radiation according to the present disclosure comprises: a flexible panel assembly extending in a first direction and detecting radiation incident on a first surface; and a bending support part coupled to the panel assembly and supporting the panel assembly, and adjusting bending of the panel assembly about at least one bending axis parallel to a second direction, wherein the bending support part comprises: a side rear cover located in a direction opposite to a third direction of at least one of one side or the other side of the panel assembly; a central rear cover located on one of one side or the other side of the side rear cover; and a torque providing part fixed to the central rear cover for providing torque to the side rear cover.

In the radiation detector according to the present disclosure, the torque providing part comprises: a torque hinge fixed to the central rear cover, extending parallel to the second direction, and providing torque in a direction in which the side rear cover folds with respect to the central rear cover about an axis parallel to the second direction; and a guide bracket coupled to the torque hinge, at least a portion of which extends parallel to the first direction, and at least a portion of which is inserted into a guide hole formed in a surface of the side rear cover in the second direction or a surface in a direction opposite to the second direction.

In the radiation detector according to the present disclosure, the guide bracket comprises: a guide bracket coupling part coupled to the torque hinge and having a cylindrical shape extending parallel to the second direction, for transmitting rotational force of the torque hinge to the side rear cover; and a guide bracket rod coupled to the guide bracket coupling part, extending parallel to the first direction, and at least a portion of which is inserted into the guide hole formed in the side rear cover.

In the radiation detector according to the present disclosure, a guide bracket groove is formed in a surface of the guide bracket rod in a direction opposite to the second direction, a guide bracket elongated hole is formed in the guide bracket rod, and the guide bracket elongated hole is located farther from the central rear cover than the guide bracket groove.

In the radiation detector according to the present disclosure, a guide bracket elongated hole is formed in the guide bracket rod, the side rear cover comprises a rear cover fixing bolt extending parallel to the second direction, passing through the guide bracket elongated hole, and fixed to the side rear cover, and the rear cover fixing bolt moves farther from the central rear cover as the side rear cover folds with respect to the central rear cover, and moves closer to the central rear cover as the side rear cover unfolds with respect to the central rear cover.

In the radiation detector according to the present disclosure, a guide bracket groove is formed in a surface of the guide bracket rod in a direction opposite to the second direction, the side rear cover comprises a rear cover fixing protrusion convex in the second direction, and the rear cover fixing protrusion is detached from the guide bracket groove when the side rear cover is folded with respect to the central rear cover, and is coupled to the guide bracket groove when the side rear cover is unfolded with respect to the central rear cover.

In the radiation detector according to the present disclosure, a rotation limit groove is formed in an outer circumferential surface of the guide bracket coupling part, a rotation limit protrusion is formed on the central rear cover toward the guide bracket coupling part, and a maximum folding angle of the side rear cover with respect to the central rear cover is determined by the rotation limit groove and the rotation limit protrusion.

The radiation detector according to the present disclosure further comprises a plurality of bending limit parts located on a front surface of the panel assembly and at least a portion of which protrudes forward, and the plurality of bending limit parts are arranged in the first direction, and when the radiation detector is folded, at least a portion of the plurality of bending limit parts contact each other to prevent the radiation detector from bending further. In addition, a program for implementing a method for operating the radiation detector of the present disclosure may be recorded on a computer-readable recording medium.

### [advantageous Effects]

In addition, the radiation detector of the present disclosure can image a large object and may have a robust structure. In addition, the radiation detector of the present disclosure may acquire an image of a small object without distortion. In addition, even when imaging a small object, damage to the radiation detector may be prevented by not being excessively folded.

In addition, the radiation detector of the present disclosure may be securely fixed to the object without damaging the pipe and without the radiation detector being damaged. In addition, the radiation detector of the present disclosure may increase user's usability and convenience and may improve the quality of the image through imaging in close contact with the object.

However, the effects of the radiation detector of the present disclosure are not limited to the above-described effects.

### DESCRIPTION OF DRAWINGS

FIG. 1 is a perspective view illustrating a radiation detector according to an embodiment of the present disclosure.

FIG. 2 is a view for explaining a panel assembly according to an embodiment of the present disclosure.

FIG. 3 illustrates a part of a panel assembly according to an embodiment of the present disclosure.

FIG. 4 illustrates a cross-section of a panel assembly according to an embodiment of the present disclosure.

FIG. 5 is a view for explaining a panel assembly according to an embodiment of the present disclosure.

FIG. 6 is a view for explaining a panel assembly according to an embodiment of the present disclosure.

FIG. 7 illustrates a part of a panel assembly according to an embodiment of the present disclosure.

FIG. 8 illustrates a panel assembly according to an embodiment of the present disclosure.

FIG. 9 illustrates a panel assembly according to an embodiment of the present disclosure.

FIG. 10 illustrates a radiation detector according to an embodiment of the present disclosure.

FIG. 11 illustrates a radiation detector according to an embodiment of the present disclosure from various viewpoints.

FIG. 12 is a view illustrating a use of a radiation detector according to an embodiment of the present disclosure.

FIG. 13 is a view for explaining a detector fixing assembly according to an embodiment of the present disclosure.

FIG. 14 is a view for explaining a detector fixing assembly according to an embodiment of the present disclosure.

FIG. 15 is a view for explaining a detector fixing assembly according to an embodiment of the present disclosure.

FIG. 16 is a view for explaining a detector fixing assembly according to an embodiment of the present disclosure.

FIG. 17 is a view for explaining a part of a detector fixing assembly according to an embodiment of the present disclosure.

FIG. 18 is a view for explaining a detector fixing assembly according to an embodiment of the present disclosure.

FIG. 19 is a view for explaining a radiation detector according to an embodiment of the present disclosure.

FIG. 20 is a view for explaining a radiation detector according to an embodiment of the present disclosure.

FIG. 21 illustrates a radiation detector according to an embodiment of the present disclosure.

FIG. 22 is a view for explaining a torque hinge according to an embodiment of the present disclosure.

FIG. 23 illustrates a part of a radiation detector according to an embodiment of the present disclosure.

FIG. 24 is a view for explaining a guide bracket rod according to an embodiment of the present disclosure.

FIG. 25 is a view for explaining a torque providing part according to an embodiment of the present disclosure.

FIG. 26 is a view for explaining a guide bracket according to an embodiment of the present disclosure.

FIG. 27 is a view for explaining a radiation detector according to an embodiment of the present disclosure.

FIG. 28 is a view for explaining a radiation detector according to an embodiment of the present disclosure.

FIG. 29 is a view for explaining a radiation detector according to an embodiment of the present disclosure.

FIG. 30 is a view for explaining a radiation detector according to an embodiment of the present disclosure.

### DETAILED DESCRIPTION

Advantages and features of the disclosed embodiments, and methods of achieving them, will become clear with reference to the embodiments described below in conjunction with the accompanying drawings. However, the present disclosure is not limited to the embodiments disclosed below but may be implemented in various different forms, and these embodiments are provided only to make the disclosure complete and to fully inform those skilled in the art of the scope of the invention.

The terms used in this specification will be briefly described, and the disclosed embodiments will be described in detail.

The terms used in this specification have been selected as general terms that are currently widely used, if possible, in consideration of their functions in the present disclosure, but this may change depending on the intention of technicians in the related art, judicial precedents, the emergence of new technologies, or the like. In addition, in specific cases, there are terms arbitrarily selected by the applicant, and in this case, the meaning thereof will be described in detail in the corresponding description part of the invention. Therefore, the terms used in the present disclosure should be defined based on the meaning they have and the overall content of the present disclosure, rather than just the names of the terms.

In this specification, a singular expression includes plural expressions unless the context clearly indicates otherwise. In addition, plural expressions include a singular expression unless the context clearly indicates otherwise.

Throughout the specification, when a part “comprises” a component, it means that it may further include other components, not excluding other components, unless otherwise specified.

In addition, the term “unit” used in the specification means a software or hardware component, and the “unit” performs certain roles. However, the “unit” is not limited to software or hardware. The “unit” may be configured to be in an addressable storage medium or configured to reproduce one or more processors. Thus, as an example, a “unit” includes components such as software components, object-oriented software components, class components, and task components, and processes, functions, attributes, procedures, subroutines, segments of program code, drivers, firmware, microcode, circuits, data, databases, data structures, tables, arrays, and variables. The functions provided in the components and “units” may be combined into a smaller number of components and “units” or further separated into additional components and “units”.

According to an embodiment of the present disclosure, a “unit” may be implemented as a processor and memory. The term “processor” should be broadly interpreted to include a general-purpose processor, a central processing unit (CPU), a microprocessor, a digital signal processor (DSP), a controller, a microcontroller, a state machine, or the like. In some environments, a “processor” may refer to an application-specific integrated circuit (ASIC), a programmable logic device (PLD), a field programmable gate array (FPGA), or the like. The term “processor” may also refer to a combination of processing devices, for example, a combination of a DSP and a microprocessor, a combination of a plurality of microprocessors, a combination of one or more microprocessors coupled to a DSP core, or any other such combination.

The term “memory” should be broadly interpreted to include any electronic component capable of storing electronic information. The term memory may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, or the like. Memory is said to be in electronic communication with a processor if the processor can read information from and/or write information to the memory. Memory integrated into a processor is in electronic communication with the processor.

Hereinafter, embodiments will be described in detail with reference to the accompanying drawings so that a person skilled in the art to which the present disclosure pertains can easily practice the embodiments. In the drawings, parts irrelevant to the description are omitted to clearly describe the present disclosure.

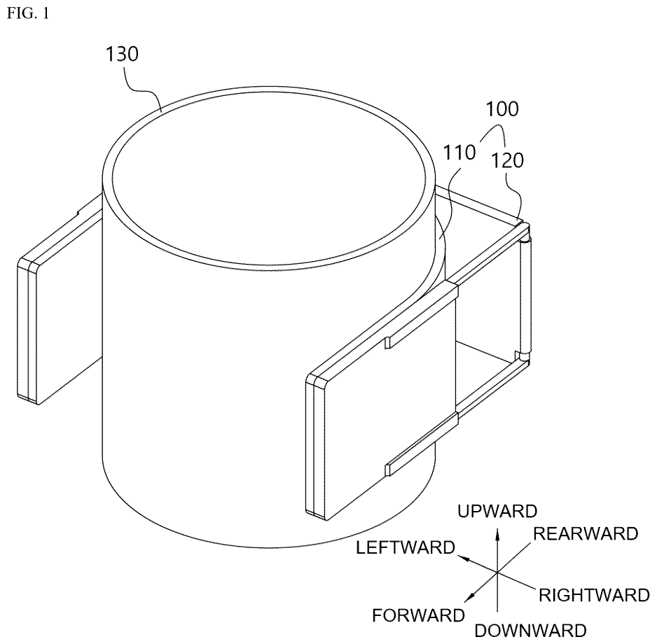

FIG. 1 is a perspective view illustrating a radiation detector according to an embodiment of the present disclosure.

The radiation detector 100 of the present disclosure may be an apparatus detecting radiation emitted from a radiation source and transmitted through an object. The radiation may include at least one of X-rays, gamma rays, and some ultraviolet rays. The radiation detector 100 may acquire a radiation image of the object by detecting the radiation. For example, the radiation image acquired by the radiation detector 100 may include at least one of an X-ray image and a Computed Tomography (CT) image.

The radiation detector 100 may comprise a panel assembly 110. The panel assembly 110 may comprise at least one of a radiation detection panel, a main plate, or a sub-plate.

The panel assembly 110 may extend in a first direction. The first direction may be a left direction. However, the present disclosure is not limited thereto, and the first direction may be a right direction. That is, the panel assembly 110 may extend in a left-right direction. The panel assembly 110 may detect radiation incident on a first surface. Here, the first surface may mean a front surface (a front side surface) of the panel assembly 110. A panel protection part for protecting the front surface of the panel assembly 110 may be located on the front surface of the panel assembly 110. That is, the panel assembly 110 comprises a panel protection part, and a light receiving element included in the panel assembly 110 may not be exposed to the outside. The panel assembly 110 may be protected from external impact by the panel protection part.

The panel assembly 110 may have flexibility. The radiation detection panel included in the panel assembly 110 may be flexible and bendable. When a surface of the object has a round surface, the panel assembly 110 may be bent to be in close contact with the surface of the object. Since the panel assembly 110 is located in close contact with the surface of the object, sharpness of the radiation image may be improved. The closer the distance between the radiation detector and the outer circumferential surface of the object, the clearer the radiation image may be, but when a round object is imaged with a radiation detector that does not bend, the distance between the radiation detector and the object is not constant, and thus distortion may occur in the radiation image. The radiation detector 100 of the present disclosure is bendable, and thus may acquire a clear radiation image. However, being bendable is not sufficient, and a structure is required in which the radiation detector 100 may be fixed in proximity to the object, and the fixing structure will be described later.

The radiation detection panel included in the panel assembly 110 may be divided into an indirect conversion type for obtaining an indirect electrical signal by visible light by using a Scintillator and a direct conversion type for obtaining a direct electrical signal from radiation by using photoconductors, according to an electrical signal acquisition method, and may be classified into a Charge-Coupled Device (CCD) type using a charge-coupled device, a CMOS type using a CMOS device of crystalline silicon, and an a-Si type using a Thin Film Transistor (TFT) substrate of Amorphous silicon, according to the type of device generating an electrical signal. The TFT panel of the present disclosure may be replaced with various methods for sensing visible light or radiation other than the TFT method.

The radiation detection panel included in the panel assembly 110 may implement digital image data with an electrical signal of a sensor and position information proportional to an incident amount of radiation by including various sensors. The panel assembly 110 may obtain an imaging result close to real time, may secure a high resolution and a wide dynamic range with relatively little radiation, and may easily store and process the imaging result due to characteristics of digital data. The panel assembly 110 includes a readout signal unit for reading an electrical signal output from a pixel array, and a gate driver for turning on a switching element so that the readout signal unit can read the electrical signal, and the electrical signal detected by the readout signal unit is converted into an image signal after undergoing a predetermined processing process in a controller or the like provided on a main board, and then transmitted to a display device for displaying an X-ray image.

The radiation detection panel included in the panel assembly 110 may comprise a configuration such as at least one of a pixel array, a readout signal unit, a gate driver circuit unit, and a main board. The readout signal unit is implemented as a plurality of ROICs (Read Out ICs) in the form of a film, and each ROIC may be connected as a connector to a main board (a first circuit unit 265 or a second circuit unit 266).

The panel assembly 110 may comprise a light receiving element generating an electrical signal by detecting radiation and a readout circuit unit reading the generated electrical signal. A control unit may process the electrical signal output from the readout circuit unit, and then generate X-ray image data constituting an X-ray image. The generated X-ray image data may be stored in a storage unit together with (or separately from) detector state information or information related to X-ray imaging.

In order to sequentially perform an operation of detecting X-ray information in the panel assembly 110 and transmitting the X-ray information to an external computer, the panel assembly 110 may use a power and data cable transmitting power supply and data communication together.

In addition, the panel assembly 110 may use WiFi and Gigabit Ethernet for wired/wireless data transmission. In addition, the control unit of the panel assembly 110 may be connected to communicate with a workstation for variables for driving an image sensor or the like.

The radiation detector 100 may comprise a bending support part 120. The bending support part 120 may be coupled to the panel assembly 110. The bending support part 120 may contact a second surface opposite to the first surface of the panel assembly 110. The second surface may be opposite to the first surface. The first surface may mean a front surface of the panel assembly 110. The second surface may mean a rear surface of the panel assembly 110. Here, for convenience of description, it is described that the bending support part 120 contacts the rear surface of the panel assembly 110, but the present disclosure is not limited thereto. The bending support part 120 may contact at least one of a rear surface, a left side surface, a right side surface, a lower surface, and an upper surface of the panel assembly 110. At least a portion of the front surface of the radiation detection panel may also contact the bending support part 120. Here, contacting means one of point contact, line contact, and surface contact.

The bending support part 120 may support the panel assembly 110. The bending support part 120 may protect the panel assembly 110. Since the panel assembly 110 is flexible and bendable, it may be difficult to keep the panel assembly 110 still with respect to the object without the bending support part 120. This is because the panel assembly 110 may be easily deformed by movement of the object or an external force. Accordingly, the bending support part 120 may be a configuration for supporting the panel assembly 110 to maintain a constant shape after being bent. In addition, the bending support part 120 may prevent the panel assembly 110 from being excessively bent, or may prevent the panel assembly 110 from being damaged from an external impact. The bending support part 120 may adjust bending of the panel assembly 110 about a bending axis parallel to a second direction intersecting the first direction. The first direction and the second direction may be perpendicular to each other. The first direction may mean a left direction. In addition, the second direction may mean an upward direction. However, the present disclosure is not limited thereto, and the second direction may be a downward direction. That is, the bending support part 120 may adjust the bending of the panel assembly 110 about at least one bending axis parallel to an up-down direction. The panel assembly 110 may also be bent as much as the bending support part 120 is bent.

The bending support part 120 may comprise various configurations for an operation of the radiation detector 100. For example, the bending support part 120 may comprise at least one of a control unit, a communication unit, an input unit, and an output unit for the operation of the radiation detector 100. In addition, the panel assembly 110 may be embedded in the bending support part 120. However, the present disclosure is not limited thereto.

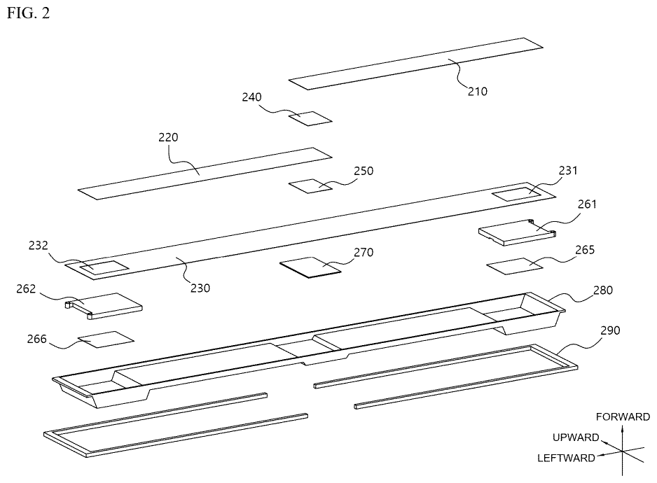

FIG. 2 is a view for explaining a panel assembly according to an embodiment of the present disclosure.

As described above, the radiation detector 100 may comprise the panel assembly 110. The radiation detection panel included in the panel assembly 110 may comprise at least one of a first radiation detection panel and a second radiation detection panel. A large radiation detection panel is required to image a large object, but it may be technically difficult to increase the size of the radiation detection panel. Accordingly, a large radiation detection panel may be formed by coupling a plurality of radiation detection panels.

The first radiation detection panel 210 extends in the first direction and may detect radiation incident on the front surface. Here, the first direction may be left or right. In addition, the second radiation detection panel 220 extends in the first direction and may detect radiation incident on the front surface. In the present disclosure, the front surface may be the same as the first surface, and the rear surface may be the same as the second surface. At least a portion of the rear surface of the first radiation detection panel 210 may overlap at least a portion of the front surface of the second radiation detection panel 220. At least one of the first radiation detection panel 210 and the second radiation detection panel 220 may be flexible. The present disclosure will be described based on an embodiment in which at least a portion of the rear surface of the first radiation detection panel 210 overlaps at least a portion of the front surface of the second radiation detection panel 220. However, the present disclosure is not limited thereto, and at least a portion of the front surface of the first radiation detection panel 210 may overlap at least a portion of the rear surface of the second radiation detection panel 220.

The first radiation detection panel 210 and the second radiation detection panel 220 may be very sensitive configurations. For example, a bent shape of the first radiation detection panel 210 and the second radiation detection panel 220 and a force applied from the outside may greatly affect a radiation image. Accordingly, the panel assembly 110 may comprise a configuration for supporting the first radiation detection panel 210 and the second radiation detection panel 220. The panel assembly 110 included in the radiation detector 100 may comprise a main plate 230. The main plate 230 may be located at rear surfaces of the first radiation detection panel 210 and the second radiation detection panel 220. The main plate 230 may support at least a portion of the first radiation detection panel 210 and the second radiation detection panel 220. The main plate 230 may be plate-shaped. Accordingly, the flexible first radiation detection panel 210 and second radiation detection panel 220 may maintain the plate shape. Since the main plate 230 is also flexible, the main plate 230 may be bent together with the radiation detection panels 210 and 220. Although the main plate 230 has a plate shape, penetration holes 231 and 232 for allowing a cable for connecting the first radiation detection panel 210 and the second radiation detection panel 220 and a control board to pass through may be formed in at least a portion thereof.

A material of the main plate 230 may be a thin plate of a composite material in which at least one material of carbon, a stainless material, a copper material, and carbon tool steel is mixed. The carbon tool steel that may be used as the main plate 230 may be one of SK1, SK2, SK3, SK4, SK5, SK6, and SK7. In order to increase surface hardness of the main plate 230, post-treatment may be performed on the material. For example, heat treatment, PVD, DLC, or the like may be performed on the material. The main plate 230 may return to its original state while maintaining bendability by using the above-described material.

In addition, the main plate 230 may have conductivity. In addition, the main plate 230 may be electrically connected to control boards 265 and 266. More specifically, the main plate 230 may be electrically connected to a ground of the control boards 265 and 266 to compensate for an insufficient ground area of the control boards 265 and 266. Noise of the radiation image may be significantly reduced by the ground area of the main plate 230.

An up-down length of the main plate 230 may be longer than up-down lengths of the first radiation detection panel 210 and the second radiation detection panel 220. Accordingly, the main plate 230 may prevent an external force in the up-down direction from being applied to the first radiation detection panel 210 and the second radiation detection panel 220. The up-down length of the first radiation detection panel 210 and the up-down length of the second radiation detection panel 220 may be almost the same.

In a portion, at least a portion of one of the first radiation detection panel 210 and the second radiation detection panel 220 may be adhered to at least a portion of the front surface of the main plate 230. An adhesive surface may be located in a central region of the front surface of the main plate 230. However, the present disclosure is not limited thereto, and the adhesive surface may be located in a region biased in a direction opposite to the first direction in the front surface of the main plate 230. In addition, the adhesive surface may be located in a region biased in the first direction in the front surface of the main plate 230. In addition, the adhesive surface may be located in at least one of a region biased in the second direction or a region biased in a direction opposite to the second direction in the front surface of the main plate 230.

More specifically, referring to FIG. 2, at least a portion of the rear surface of the first radiation detection panel 210 may be adhered to at least a portion of the front surface of the second radiation detection panel with a first adhesive 240. A region where the first radiation detection panel 210 and the second radiation detection panel 220 are adhered may be referred to as a first adhesive region. That is, at least a portion of the rear surface of the first radiation detection panel 210 may be adhered to at least a portion of the front surface of the second radiation detection panel 220 by the first adhesive 240 in the first adhesive region. The first adhesive region may be formed on one side of the rear surface of the first radiation detection panel 210. In addition, the first adhesive region may be formed on the other side of the front surface of the second radiation detection panel 220. Here, one side may mean a left side, and the other side may mean a right side.

In the present disclosure, adhesion may mean being adhered through an adhesive. However, the present disclosure is not limited thereto, and in the present disclosure, adhesion should be interpreted as including coupling by an additional configuration. For example, adhesion of two configurations includes being coupled by using a screw, or being coupled by a bracket. In this case, the adhesive includes a screw or a bracket.

The first adhesive region may mean a region where the first radiation detection panel 210 and the second radiation detection panel 220 overlap when the radiation detector is viewed from the front. The first radiation detection panel 210 and the second radiation detection panel 220 in the first adhesive region may be adhered by an adhesive, but are not limited thereto, and may be coupled by other methods.

In the present disclosure, the adhesive region may be the same as a region of the adhesive, but is not limited thereto. In the present disclosure, the adhesive region and the overlap region may have the same meaning. The adhesive region may be larger than the region of the adhesive. The first radiation detection panel 210 and the second radiation detection panel 220 may be coupled by applying an adhesive to at least a portion of the adhesive region. In addition, the adhesive region of the first radiation detection panel 210 and the second radiation detection panel 220 may be coupled by a configuration other than the adhesive. Therefore, the adhesive region should not be interpreted as being limited to a region where the adhesive is applied.

At least a portion of the rear surface of the second radiation detection panel 220 may be adhered to at least a portion of the main plate 230 with a second adhesive 250. A region where the second radiation detection panel 220 and the main plate 230 are adhered may be referred to as a second adhesive region. That is, at least a portion of the rear surface of the second radiation detection panel 220 may be adhered to at least a portion of the main plate 230 by the second adhesive 250 in the second adhesive region. The second adhesive region may be formed on the other side of the rear surface of the second radiation detection panel 220. In addition, the second adhesive region may be formed in the center of the front surface of the main plate 230.

The first adhesive 240 and the second adhesive 250 may be made of the same material. However, the present disclosure is not limited thereto, and the first adhesive 240 and the second adhesive 250 may be made of different materials. An area of the first adhesive 240 may be the same as an area of the second adhesive 250. However, the present disclosure is not limited thereto.

The first adhesive region and the second adhesive region may be the same region in a plane formed by an upward direction and a leftward direction. That is, as illustrated in FIG. 2, the first adhesive region and the second adhesive region may be formed in the center of the main plate 230.

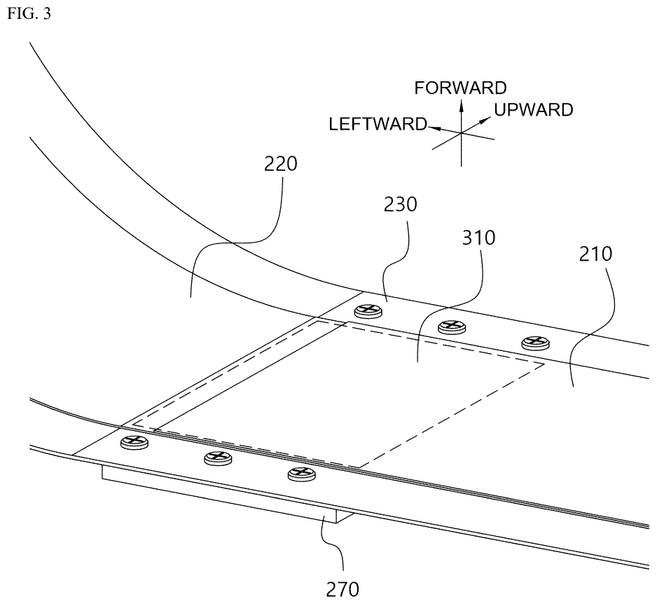

Hereinafter, FIG. 3 will be temporarily referred to in order to describe an adhesive region according to an embodiment of the present disclosure.

FIG. 3 illustrates a part of a panel assembly according to an embodiment of the present disclosure.

FIG. 3 may illustrate a state after the first radiation detection panel 210, the second radiation detection panel 220, and the main plate 230 are coupled. As described in FIG. 2, the first adhesive region and the second adhesive region may be identical. For example, in FIG. 3, an adhesive region 310 may be formed in the center of the main plate 230. Since the first radiation detection panel 210 and the second radiation detection panel 220 are fixed by the adhesive, the first radiation detection panel 210 and the second radiation detection panel 220 in the adhesive region 310 may not move with respect to the main plate 230 even when the radiation detector 100 is bent. The adhesive region 310 may be a kind of reference position when the radiation detector 100 generates a radiation image. For example, the radiation detector 100 may need to merge signals of the first radiation detection panel 210 and the second radiation detection panel 220 in order to generate an image. At this time, when alignment of the first radiation detection panel 210 and the second radiation detection panel 220 is misaligned, a method of merging the signals may need to be changed, which may be inconvenient. However, according to the radiation detector 100 of the present disclosure, since the first radiation detection panel 210 and the second radiation detection panel 220 are fixed to the adhesive region 310, a clear radiation image may always be generated by merging the signals in the same method. In addition, the first radiation detection panel 210 and the second radiation detection panel 220 may be closely adhered in the adhesive region 310. The greater the distance between the first radiation detection panel 210 and the second radiation detection panel 220, the greater the difference between an image signal generated in the first radiation detection panel 210 and an image signal generated in the second radiation detection panel 220, which may make it difficult to properly merge the images. However, since the first radiation detection panel 210 and the second radiation detection panel 220 are firmly attached in the adhesive region 310, a merged image may be easily generated.

In addition, the radiation detector 100 may not create a merged image in the entire adhesive region. The radiation detector 100 may create a merged image in at least a portion of the adhesive region, and may create an image based on a signal acquired from one of the first radiation detection panel 210 or the second radiation detection panel 220 in the remaining region. A region where the merged image is created may be referred to as a merged region. The merged region may be larger or smaller than the adhesive region. More specifically, the radiation detector 100 may generate a first image based on a signal acquired from the first radiation detection panel 210 for a region outside the merged region and to the right of the merged region. In addition, the radiation detector 100 may generate a second image based on a signal acquired from the second radiation detection panel 220 for a region outside the merged region and to the left of the merged region. The radiation detector 100 may generate a third image based on signals acquired from the first radiation detection panel 210 and the second radiation detection panel 220 for a region inside the merged region. The radiation detector 100 may acquire an entire image by connecting the first image, the second image, and the third image.

However, the present disclosure is not limited thereto. The radiation detector 100 may generate a first image based on a signal acquired from the first radiation detection panel 210 for the merged region and a region to the right of the merged region. The radiation detector 100 may generate a second image based on a signal acquired from the second radiation detection panel 220 for the merged region and a region to the left of the merged region. The radiation detector 100 may acquire an entire image by merging the first image and the second image. The radiation detector 100 may use overlapping images appearing in the first image and the second image to merge the first image and the second image.

A fixing bracket 270 may be formed on a rear surface of the adhesive region 310 of the main plate 230, and thus portions included in the adhesive region 310 of the first radiation detection panel 210 and the second radiation detection panel 220 may not be bendable. The fixing bracket 270 is fixed to the center of the main plate 230 to which the first radiation detection panel 210 and the second radiation detection panel 220 are attached, and may create a horizontal section where the first radiation detection panel 210, the second radiation detection panel 220, and the main plate 230 cannot be bent.

As such, by making the overlapping region of the first radiation detection panel 210 and the second radiation detection panel 220 non-bendable, the radiation detector 100 may more clearly generate an image based on signals acquired in the overlapping region (adhesive region 310). In addition, it is possible to prevent the first radiation detection panel 210 and the second radiation detection panel 220 from being separated from the main plate 230.

Referring again to FIG. 2, the radiation detector 100 may comprise the fixing bracket 270. The fixing bracket 270 may be fixed to the rear surface of the main plate 230. The fixing bracket 270 may support at least a portion of the first adhesive region and the second adhesive region where the first radiation detection panel 210 and the second radiation detection panel 220 overlap. The fixing bracket 270 may be made of a material that is hardly bendable. The fixing bracket 270 may be made of the same material as the main plate 230, but may be thicker than the main plate 230. However, the present disclosure is not limited thereto. Referring to FIG. 2, the fixing bracket 270 may be located behind the first adhesive 240 and the second adhesive 250.

According to various embodiments of the present disclosure, the radiation detector may not comprise the fixing bracket 270. Instead, the radiation detector 100 comprises at least one of the first adhesive 240 and the second adhesive 250, and at least one of the first adhesive 240 and the second adhesive 250 may serve as the fixing bracket 270. That is, the first adhesive 240 and the second adhesive 250 may minimize bending of the overlapping region of the first radiation detection panel 210 and the second radiation detection panel 220. The first adhesive 240 and the second adhesive 250 may be made of an elastic material, or may be made of a material that hardly bends. Accordingly, the radiation detector 100 may more clearly generate an image based on signals acquired in the overlapping region.

The main plate 230 may comprise a first cable penetration hole 231 on the other side and a second cable penetration hole 232 on the one side. The panel assembly 110 included in the radiation detector 100 may comprise a first circuit case 261 and a second circuit case 262. The first cable penetration hole 231 is a space for allowing a first flexible film to pass through, and the second cable penetration hole 232 may be a space for allowing a second flexible film to pass through.

The first circuit case 261 may be coupled to the rear surface of the main plate 230. The first circuit case 261 may be coupled to the other side of the rear surface of the main plate 230. The first circuit case 261 may comprise a first circuit unit 265 for being electrically connected to the first radiation detection panel 210. The first circuit case 261 may not be bendable. The first circuit case 261 may be made of the same material as the fixing bracket 270. However, the present disclosure is not limited thereto. The first circuit unit 265 may be a configuration for controlling the first radiation detection panel 210 or receiving data from the first radiation detection panel 210. In addition, the first circuit unit 265 may be a configuration for generating a radiation image based on a signal received from the first radiation detection panel 210.

The second circuit case 262 may be coupled to the rear surface of the main plate 230. The second circuit case 262 may be coupled to the one side of the rear surface of the main plate 230. The second circuit case 262 may comprise a second circuit unit 266 for being electrically connected to the second radiation detection panel 220. The second circuit case 262 may not be bendable. The second circuit case 262 may be made of the same material as the fixing bracket 270. However, the present disclosure is not limited thereto. The second circuit unit 266 may be a configuration for controlling the second radiation detection panel 220 or receiving data from the second radiation detection panel 220. In addition, the second circuit unit 266 may be a configuration for generating a radiation image based on a signal received from the second radiation detection panel 220.

The panel assembly 110 included in the radiation detector 100 may comprise a first flexible film and a second flexible film.

The first flexible film may pass through the first cable penetration hole 231 and electrically connect the first circuit case 261 and the first radiation detection panel 210. More specifically, the first flexible film may electrically connect the first radiation detection panel 210 and the first circuit unit 265.

The second flexible film may pass through the second cable penetration hole 232 and electrically connect the second circuit case 262 and the second radiation detection panel 220. More specifically, the second flexible film may electrically connect the second radiation detection panel 220 and the second circuit unit 266.

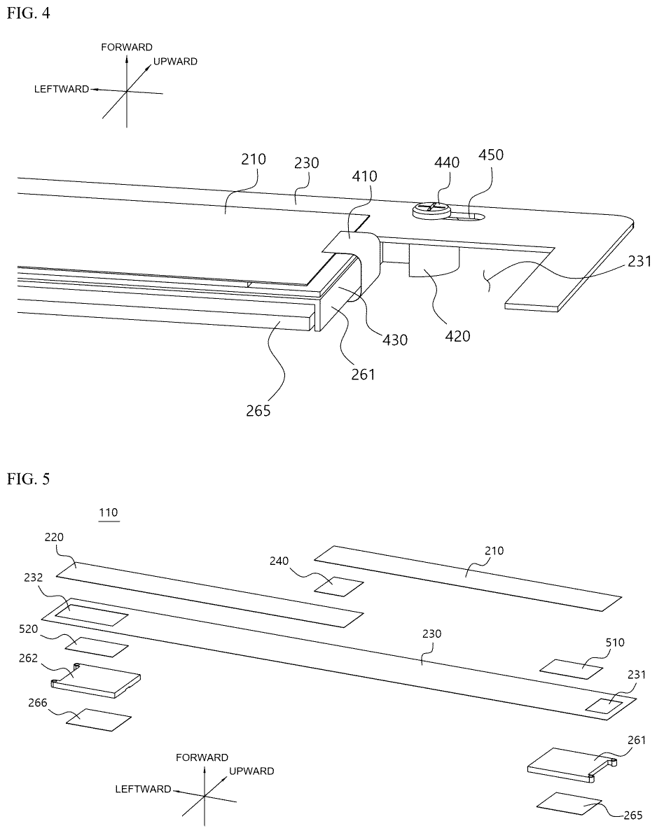

Hereinafter, FIG. 4 will be referred to in order to describe the flexible film.

FIG. 4 illustrates a cross-section of a panel assembly according to an embodiment of the present disclosure.

In FIG. 4, only a configuration related to the first flexible film is illustrated for convenience of description. However, the same description as the description of the configuration related to the first flexible film may be applied to a configuration related to the second flexible film.

As described above, the radiation detector 100 may comprise a first flexible film 410. There may be a plurality of first flexible films 410. However, only some of the first flexible films 410 may be illustrated in FIG. 4.

The first flexible film 410 extending from the first radiation detection panel 210 may pass through the first cable penetration hole 231. In addition, the first flexible film 410 may be connected to the first circuit unit 265 inside the first circuit case 261.

Referring to FIG. 2 and FIG. 4, at least one of the first circuit case 261 and the second circuit case 262 may comprise a protruding coupling part 420 extending in at least one of a direction opposite to the first direction or the first direction.

Hereinafter, the protruding coupling part 420 of the first circuit case 261 will be described with reference to FIG. 4. The same description as that of the first circuit case 261 may be applied to the second circuit case 262.

Referring to FIG. 4, the protruding coupling part 420 may be formed on an upper side and a lower side of a right side surface 430 of the first circuit case 261. A recess formed by the right side surface 430 of the first circuit case 261 and the protruding coupling part 420 may correspond to the first cable penetration hole 231. That is, when the radiation detector 100 is not bent, the first circuit case 261 may not invade the first cable penetration hole 231. Accordingly, the first flexible film 410 may not be damaged by the main plate 230 or the first circuit case 261. When the radiation detector 100 is bent, the first circuit case 261 may move to the right with respect to the main plate 230. Even at this time, a sharp portion of the main plate 230 does not contact the first flexible film 410, and the smoothly processed right side surface 430 of the first circuit case 261 contacts the first flexible film 410, thereby preventing the first flexible film 410 from being damaged.

A screw hole may be formed in the protruding coupling part 420. A bolt 440 may pass through an elongated hole 450 extending in the first direction formed in the main plate 230 and be coupled to the protruding coupling part 420. In this way, the first circuit case 261 may be fixed to the main plate 230. In this way, at least one of the first circuit case 261 and the second circuit case 262 may be fixed to the main plate 230. However, the present disclosure is not limited thereto.

Since the bolt 440 is coupled to the elongated hole 450 of the main plate 230, the first circuit case 261 may move to the left or right with respect to the main plate 230 by the length of the elongated hole 450. For example, when the radiation detector 100 is not bent as illustrated in FIG. 4, the bolt 440 may be located on the left side of the elongated hole 450. In addition, as the radiation detector 100 is bent, the bolt 440 may move to the right of the elongated hole 450. Similarly, as the radiation detector 100 is bent, the first circuit case 261 may move to the right with respect to the main plate 230. As such, by allowing the circuit cases 261 and 262 to move with respect to the main plate 230, it is possible to prevent the flexible film 410 from being damaged. In addition, by allowing the circuit cases 261 and 262 to move with respect to the main plate 230, it is possible to prevent the radiation detector 100 from being excessively bent, thereby preventing the radiation detection panel from being damaged.

However, the present disclosure is not limited to an embodiment, and the first circuit case 261 may not move with respect to the main plate 230 even when the radiation detector 100 is bent.

In addition, referring to FIG. 2, the other side of the first radiation detection panel 210 and the one side of the second radiation detection panel 220 may not be fixed with respect to the main plate 230. Here, the one side may mean a left side, and the other side may mean a right side. As the radiation detector 100 is bent, the other side of the first radiation detection panel 210 and the one side of the second radiation detection panel 220 may be movable with respect to the main plate 230. A moving direction of the other side of the first radiation detection panel 210 as the radiation detector 100 is bent may be the same as a moving direction of the first circuit case 261. In addition, a moving direction of the one side of the second radiation detection panel 220 as the radiation detector 100 is bent may be the same as a moving direction of the second circuit case 262. For example, the other side of the rear surface of the first radiation detection panel 210 and the front surface of the first circuit case 261 may be coupled. In addition, the one side of the rear surface of the second radiation detection panel 220 and the front surface of the second circuit case 262 may be coupled. The coupling may be by a bracket, a screw, or an adhesive.

More specifically, as the radiation detector 100 is bent, the other side of the first radiation detection panel 210 may move to the right. In addition, as the radiation detector 100 is bent, the other side of the first circuit case 261 may move to the right. In addition, as the radiation detector 100 is bent, the one side of the second radiation detection panel 220 may move to the left. In addition, as the radiation detector 100 is bent, the one side of the second circuit case 262 may move to the left. Accordingly, even when the radiation detector 100 is bent, the first flexible film 410 between the first radiation detection panel 210 and the first circuit case 261 and the second flexible film between the second radiation detection panel 220 and the second circuit case 262 may maintain an almost constant shape. According to the radiation detector 100 of the present disclosure, the first flexible film 410 and the second flexible film may be prevented from being damaged. Accordingly, durability of the radiation detector 100 may be improved.

Referring again to FIG. 2, the radiation detector 100 may comprise a rear housing 280 for protecting the rear surfaces of the radiation detection panels 210 and 220. In addition, the radiation detector 100 may comprise an edge reinforcement part 290 for protecting an edge of the rear housing 280.

The configurations described in FIG. 2 may be included in the panel assembly 110. Hereinafter, various embodiments of the radiation detector 100 will be described.

FIG. 5 is a view for explaining a panel assembly according to an embodiment of the present disclosure.

A description similar to that of FIG. 2 may be applied to FIG. 5. Hereinafter, a description of FIG. 5 overlapping with that of FIG. 2 will be omitted. That is, hereinafter, FIG. 5 will be described focusing on differences from FIG. 2.

The first adhesive region may be an overlapping region of one side of the first radiation detection panel 210 and the other side of the second radiation detection panel 220. Here, the one side may be a left side, and the other side may be a right side. The one side of the first radiation detection panel 210 and the other side of the second radiation detection panel 220 may be coupled by the first adhesive 240 located in the first adhesive region.

In addition, the second adhesive region may be formed on one of the other side of the first radiation detection panel 210 or one side of the second radiation detection panel 220. Here, the one side may be a left side, and the other side may be a right side. One of the other side of the first radiation detection panel 210 or the one side of the second radiation detection panel may be adhered to the main plate 230 by a second adhesive 510 located in the second adhesive region. FIG. 5 illustrates that the second adhesive region is formed on the first radiation detection panel 210. Unlike FIG. 2, in FIG. 5, the first adhesive region and the second adhesive region may be located at different places on a plane formed by a leftward direction and an upward direction.

One of the other side of the first radiation detection panel 210 or the one side of the second radiation detection panel 220, which is not adhered to the main plate 230, may be slidable on the main plate 230. Accordingly, when the radiation detector 100 is bent, the main plate 230 may not damage the first radiation detection panel 210 or the second radiation detection panel 220.

Referring to FIG. 5, the second adhesive region may be formed on the other side of the first radiation detection panel 210. In addition, one side of the rear surface of the second radiation detection panel 220 may be adhered to at least a portion of a front surface of the second circuit case 262 in a third adhesive region. The front surface of the first circuit case 261 may be coupled to the main plate 230. The first circuit case 261 and the second circuit case 262 are made of a relatively hard material, and thus may prevent the other side of the first radiation detection panel 210 and the one side of the second radiation detection panel 220 from being damaged by an external impact, respectively.

The one side of the second radiation detection panel 220, which is not adhered to the main plate 230, may be slidable on the main plate 230. More specifically, when the radiation detector 100 is not bent, the one side of the second radiation detection panel 220 may be located relatively to the right with respect to the main plate 230. When the radiation detector 100 is bent, the one side of the second radiation detection panel 220 may be located relatively to the left with respect to the main plate 230.

As illustrated in FIG. 5, when the one side of the second radiation detection panel 220 is slidable on the main plate 230, the second flexible film (not illustrated) may be damaged by movement of the second radiation detection panel 220 with respect to the main plate 230. In order to prevent this, the one side of the rear surface of the second radiation detection panel 220 may be adhered to the front surface of the second circuit case 262. A region where the second radiation detection panel 220 and the second circuit case 262 are adhered may be referred to as a third adhesive region. The one side of the rear surface of the second radiation detection panel 220 may be adhered to the front surface of the second circuit case 262 by a third adhesive 520 located in the third adhesive region.

When the one side of the second radiation detection panel 220 slides, the second circuit case 262 may also slide with respect to the main plate 230. For example, as the radiation detector 100 is bent, the one side of the second radiation detection panel 220 and the second circuit case 262 may move to the left with respect to the main plate 230. Conversely, as the radiation detector 100 is unfolded, the one side of the second radiation detection panel 220 and the second circuit case 262 may move to the right with respect to the main plate 230. In addition, the other side of the first radiation detection panel 210 and the first circuit case 261 may be fixed with respect to the main plate 230. Accordingly, according to the radiation detector 100 of the present disclosure, the first flexible film and the second flexible film may be prevented from being damaged.

In addition, referring to FIG. 5, unlike FIG. 2, the radiation detector 100 may not comprise the fixing bracket 270. When the fixing bracket 270 is present, a portion that is difficult to bend is generated in the center of the main plate 230, and thus it may be difficult for the radiation detector 100 to be in sufficiently close contact with the object. Accordingly, the fixing bracket 270 may be removed so that the radiation detector 100 is in sufficiently close contact with the object. Even if the fixing bracket 270 is removed, the one side of the first radiation detection panel 210 is fixed to the other side of the second radiation detection panel 220 by the first adhesive 240 in the first adhesive region, and thus a merged image may be easily restored based on a signal based on the first radiation detection panel 210 and a signal based on the second radiation detection panel 220.

As illustrated in FIG. 5, an area of the first cable penetration hole 231 may be smaller than an area of the second cable penetration hole 232. Alternatively, a length of the first cable penetration hole 231 in the left-right direction may be smaller than a length of the second cable penetration hole 232 in the left-right direction. This is to secure a space for the second flexible film, which moves together, to move when the one side of the second radiation detection panel 220 and the second circuit case 262 slide. Accordingly, according to the radiation detector 100 of the present disclosure, the flexible film may be prevented from being damaged, and durability of the radiation detector 100 may be high.

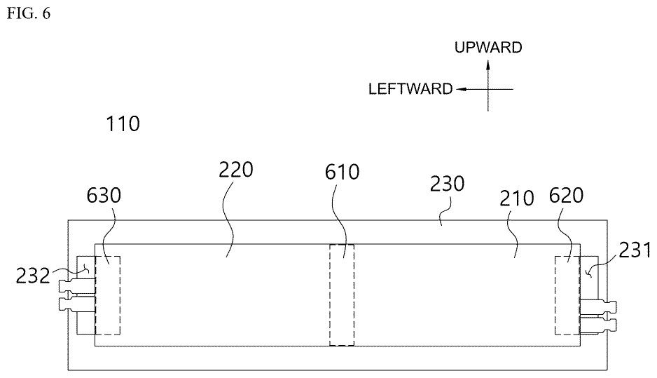

FIG. 6 is a view for explaining a panel assembly according to an embodiment of the present disclosure.

The panel assembly 110 manufactured according to FIG. 5 may be as illustrated in FIG. 6.

A first adhesive region 610 may be formed in the center of the panel assembly 110. The first adhesive region 610 may be a region where the first radiation detection panel 210 and the second radiation detection panel 220 are coupled. A first adhesive may be used in the first adhesive region 610. A second adhesive region 620 may be formed on the other side of the panel assembly 110. The second adhesive region 620 may be a region where one of the first radiation detection panel 210 or the second radiation detection panel 220 is coupled to the main plate 230. A second adhesive may be used in the second adhesive region 620. A third adhesive region 630 may be formed on one side of the panel assembly 110. FIG. 6 illustrates an embodiment in which the first radiation detection panel 210 is coupled to the main plate 230. The third adhesive region 630 may be a region where one of the second radiation detection panel 220 or the first radiation detection panel 210 is coupled to one of the second circuit case 262 or the first circuit case 261. FIG. 6 illustrates an embodiment in which the second radiation detection panel 220 is coupled to the second circuit case 262. A third adhesive may be used in the third adhesive region 630.

Referring to FIG. 6, an up-down length of the third adhesive region 630 may be shorter than an up-down length of at least one of the first adhesive region 610 or the second adhesive region 620. This is because the second adhesive region 620 must be smaller than a region of the second cable penetration hole 232, and the second cable penetration hole 232 cannot be formed large in order to maintain robustness of the main plate 230. A left-right length of the first adhesive region 610 may be shorter than a left-right length of at least one of the second adhesive region 620 or the third adhesive region 630. This is to minimize the overlapping region of the first radiation detection panel 210 and the second radiation detection panel 220.

In the present disclosure, the adhesive region means a region where two members are coupled, and should not be interpreted as being limited to a region coupled by an adhesive. In the adhesive region, the two members may be coupled by a method other than an adhesive. For example, coupling by magnetic force, coupling by welding, or screw coupling may be used.

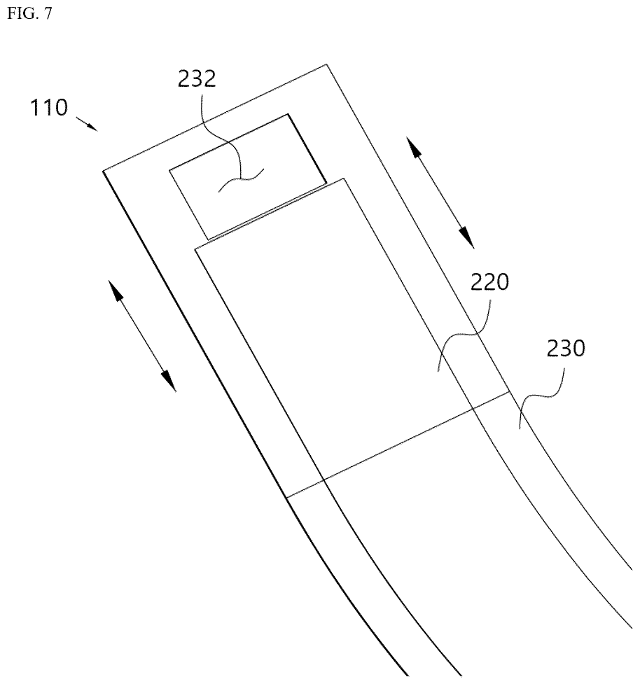

FIG. 7 illustrates a part of a panel assembly according to an embodiment of the present disclosure.

FIG. 7 relates to the panel assembly 110 having the same structure as FIG. 6. Referring to FIG. 7, one side of the second radiation detection panel 220 may be slidable with respect to the main plate 230. Since the structure in which the one side of the second radiation detection panel 220 is movable with respect to the main plate 230 has already been described, an overlapping description thereof will be omitted.

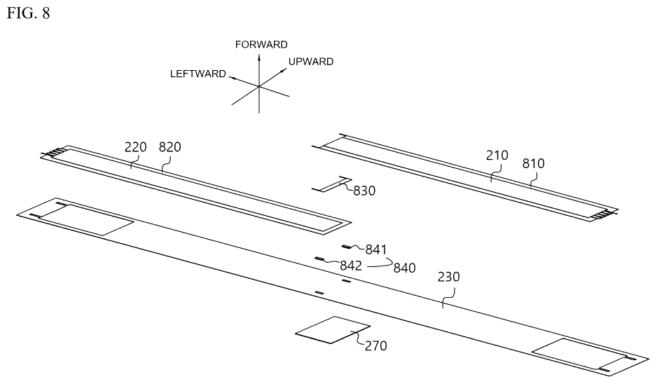

FIG. 8 illustrates a panel assembly according to an embodiment of the present disclosure.

The first radiation detection panel 210 may comprise at least one of a first sub-plate 810 or a first shielding sheet on a rear surface thereof. In addition, the second radiation detection panel 220 may comprise at least one of a second sub-plate 820 or a second shielding sheet on a rear surface thereof.

First, FIG. 8 illustrates a case where the first radiation detection panel 210 comprises the first sub-plate 810 on the rear surface thereof, and the second radiation detection panel 220 comprises the second sub-plate 820 on the rear surface thereof. Since the radiation detection panels 210 and 220 are sensitive configurations, it may be difficult to handle them without defects during manufacturing. Accordingly, the radiation detection panels 210 and 220 are sometimes manufactured with the sub-plates 810 and 820 coupled to rear surfaces thereof. Since the sub-plates 810 and 820 prevent an external impact, using the radiation detection panels 210 and 220 to which the sub-plates 810 and 820 are coupled may be a method of significantly reducing a defect rate.

In addition, when the sub-plate 810 is used, the first radiation detection panel 210 and the second radiation detection panel 220 may be robustly coupled. For example, the first radiation detection panel 210 and the second radiation detection panel 220 may be connected by fixing the first sub-plate 810 and the second sub-plate 820 by using a panel fixing bracket 840.

More specifically, an upper side of the first sub-plate 810 and an upper side of the second sub-plate 820 may be fixed by using a first panel fixing bracket 841, and a lower side of the first sub-plate 810 and a lower side of the second sub-plate 820 may be fixed by using a second panel fixing bracket 842. The panel fixing bracket 840 may couple not only the first sub-plate 810 and the second sub-plate 820 but also the main plate 230. Accordingly, there is an effect that the first radiation detection panel 210, the second radiation detection panel 220, and the main plate 230 may be coupled at once.

FIG. 8 illustrates a case where the panel fixing bracket 840 is in the center of the panel assembly 110. In this case, one side of the second radiation detection panel 220 and the other side of the first radiation detection panel 210 may be slidable with respect to the main plate 230.

In order to fix more robustly, the first sub-plate 810 and the second sub-plate 820 may be fixed by using a first adhesive 830. The first adhesive 830 may be formed in a region of the second sub-plate 820. Since the second radiation detection panel 220 is located on a front surface of the second sub-plate 820, the second radiation detection panel 220 may protrude forward with respect to the second sub-plate 820. The first adhesive 830 is formed in the region of the second sub-plate 820, and a height of the first adhesive 830 may be similar to a height of the second radiation detection panel 220. Accordingly, in the first adhesive region, the rear surface of the first radiation detection panel 210 may be filled with the second radiation detection panel 220 and the first adhesive 830. In addition, the first radiation detection panel 210 and the second radiation detection panel 220 may be robustly coupled.

Next, the first radiation detection panel 210 may comprise a first shielding sheet on the rear surface thereof, and the second radiation detection panel 220 may comprise a second shielding sheet on the rear surface thereof. The structure may be similar to FIG. 8.

In the case of radiation inspection, radiation may be created by scattered electrons. The radiation generated in this way is absorbed by a radiation film or the radiation detection panels 210 and 220 of the radiation detector 100, causing distortion in an image to be actually obtained. In this case, in order to prevent scattering noise generated by scattering of electrons, a shielding sheet may be added to the rear surfaces of the radiation detection panels 210 and 220 of the radiation detector 100 to minimize distortion. The shielding sheet may use various materials such as lead, tungsten, and a composite capable of shielding radiation. In addition, a thickness of the shielding sheet may be adjusted according to a degree of scattering.

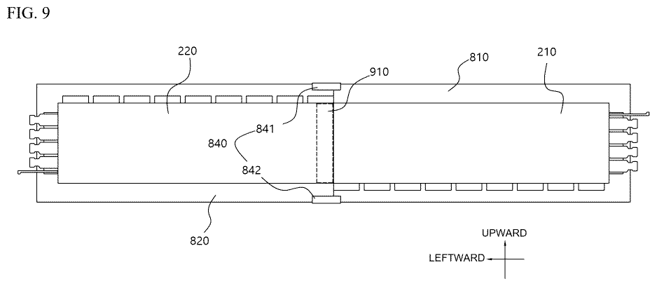

FIG. 9 illustrates a panel assembly according to an embodiment of the present disclosure.

FIG. 9 illustrates a panel assembly assembled in the same manner as FIG. 8. Referring to FIG. 9, the panel fixing bracket 840 may couple the first sub-plate 810 included on the rear surface of the first radiation detection panel 210, the second sub-plate 820 included on the rear surface of the second radiation detection panel 220, and the main plate 230. Since the first sub-plate 810 and the second sub-plate 820 cover the main plate 230, the main plate 230 may not be illustrated in FIG. 9.

It may be confirmed that a left-right width of an overlapping region 910 of FIG. 9 is narrower than that of the first adhesive region 610 of FIG. 6. This is because it is not necessary to widen the overlapping region 910 because the panel fixing bracket 840 may couple the configurations more robustly than an adhesive. Accordingly, according to the radiation detector 100 of the present disclosure, a production manufacturing cost may be reduced, and a manufacturing method is easy, and thus mass production may be possible.

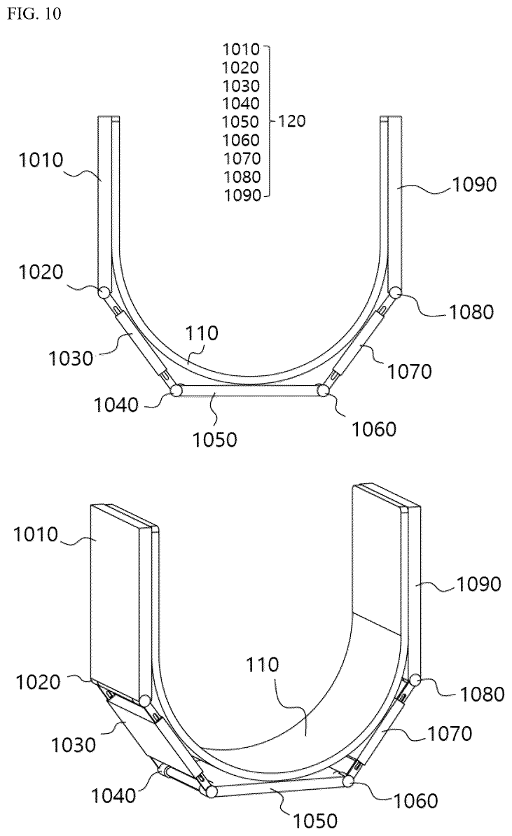

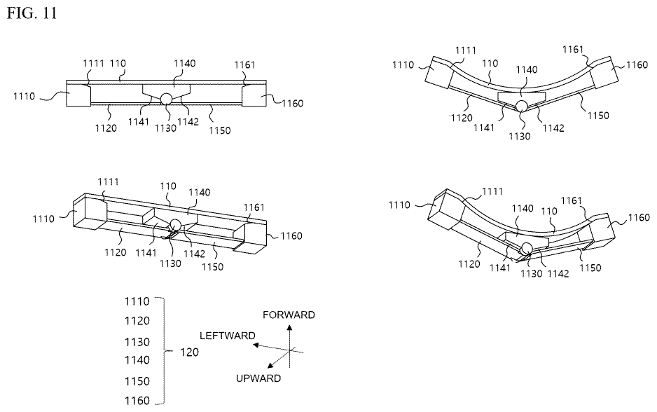

FIG. 10 illustrates a radiation detector according to an embodiment of the present disclosure.

As described above, the radiation detector 100 may comprise the panel assembly 110 and the bending support part 120.

The bending support part 120 may be located at a rear surface of the main plate 230. Being located at the rear surface of the main plate 230 may not mean that the bending support part 120 contacts the main plate 230. However, the present disclosure is not limited thereto.

The bending support part 120 may support the panel assembly 110 comprising the first radiation detection panel 210, the second radiation detection panel 220, and the main plate 230.

The bending support part 120 may further comprise the following configurations.

The bending support part 120 may comprise at least one of a first support bracket 1010, a first hinge 1020, a first connection bracket 1030, a second hinge 1040, a base bracket 1050, a third hinge 1060, a second connection bracket 1070, a fourth hinge 1080, and a second support bracket 1090.

The first support bracket 1010 may support one side of the panel assembly 110. The first support bracket 1010 may be coupled to the one side of the panel assembly 110. An area of at least a portion of the first support bracket 1010 may be coupled to an area of at least a portion of the one side of the panel assembly 110. However, the present disclosure is not limited thereto.

The first hinge 1020 may be a configuration for connecting the first support bracket 1010 and the first connection bracket 1030. Through the first hinge 1020, the first support bracket 1010 may be rotatable with respect to the first connection bracket 1030. The first hinge 1020 may be located on the other side of the first support bracket 1010 and on one side of the first connection bracket 1030.

The first connection bracket 1030 may be coupled to the first hinge 1020. The first connection bracket 1030 may be extendable and retractable. For example, at least one arm included in the first connection bracket 1030 may extend out from the first connection bracket 1030, or may be accommodated into the first connection bracket 1030, such that the first connection bracket 1030 may be extendable and retractable. Even when the radiation detector 100 is bent by extension and retraction of the first connection bracket 1030, the panel assembly 110 may form a natural curved surface. In addition, by the extension and retraction of the first connection bracket 1030, the bending support part 120 may support the panel assembly 110 regardless of whether the radiation detector 100 is bent.

The second hinge 1040 may be a configuration for connecting the first connection bracket 1030 and the base bracket 1050. Through the second hinge 1040, the first connection bracket 1030 may be rotatable with respect to the base bracket 1050. The second hinge 1040 may be located on the other side of the first connection bracket 1030 and on one side of the base bracket 1050.

The base bracket 1050 may be a configuration for supporting a center of the panel assembly 110. The base bracket 1050 may be coupled to a rear surface of the center of the panel assembly 110. However, the present disclosure is not limited thereto.

The third hinge 1060 may be a configuration for connecting the base bracket 1050 and the second connection bracket 1070. Through the third hinge 1060, the base bracket 1050 may be rotatable with respect to the second connection bracket 1070. The third hinge 1060 may be located on the other side of the base bracket 1050 and on one side of the second connection bracket 1070.

The second connection bracket 1070 may be coupled to the third hinge 1060. The second connection bracket 1070 may be extendable and retractable. For example, at least one arm included in the second connection bracket 1070 may extend out from the second connection bracket 1070, or may be accommodated into the second connection bracket 1070, such that the second connection bracket 1070 may be extendable and retractable. Even when the radiation detector 100 is bent by extension and retraction of the second connection bracket 1070, the panel assembly 110 may form a natural curved surface. In addition, by the extension and retraction of the second connection bracket 1070, the bending support part 120 may support the panel assembly 110 regardless of whether the radiation detector 100 is bent. The second connection bracket 1070 may have the same structure as the first connection bracket 1030.

The fourth hinge 1080 may be a configuration for connecting the second connection bracket 1070 and the second support bracket 1090. Through the fourth hinge 1080, the second connection bracket 1070 may be rotatable with respect to the second support bracket 1090. The fourth hinge 1080 may be located on the other side of the second connection bracket 1070 and on one side of the second support bracket 1090.

The second support bracket 1090 may be coupled to the fourth hinge 1080. The second support bracket 1090 may support the other side of the panel assembly 110. The second support bracket 1090 may be coupled to the other side of the panel assembly 110. An area of at least a portion of the second support bracket 1090 may be coupled to an area of at least a portion of the other side of the panel assembly 110. However, the present disclosure is not limited thereto. The second support bracket 1090 may have a similar shape to the first support bracket 1010.

The first hinge 1020, the second hinge 1040, the third hinge 1060, and the fourth hinge 1080 may be configurations that bend when an external force is applied by a user, but maintain a current posture when no external force is applied by the user. Accordingly, the user may easily make the radiation detector 100 take an optimal posture for imaging the object. At least one of the first hinge 1020, the second hinge 1040, the third hinge 1060, and the fourth hinge 1080 may comprise a torque hinge. However, the present disclosure is not limited thereto.

Since a plurality of hinges such as the first hinge 1020, the second hinge 1040, the third hinge 1060, and the fourth hinge 1080 are used, the radiation detector 100 may support a wide range of curvature.

FIG. 11 illustrates a radiation detector according to an embodiment of the present disclosure from various viewpoints.

FIG. 11 may illustrate an embodiment different from FIG. 10.

The bending support part 120 may comprise at least one of a first support bracket 1110, a first connection bracket 1120, a central hinge 1130, a base bracket 1140, a second connection bracket 1150, and a second support bracket 1160.

The first support bracket 1110 may be a configuration for supporting one side of the panel assembly 110. The first support bracket 1110 may be coupled to the one side of the panel assembly 110. An area of at least a portion of the first support bracket 1110 may be coupled to an area of at least a portion of the one side of the panel assembly 110. However, the present disclosure is not limited thereto.

The first connection bracket 1120 may be coupled to the first support bracket 1110. The first connection bracket 1120 may be thinner in a front-rear direction than the first support bracket 1110. One end of the first connection bracket 1120 may be coupled to the other end of the first support bracket 1110. The first connection bracket 1120 may extend to the right. The other end of the first connection bracket 1120 may be coupled to the central hinge 1130. The first connection bracket 1120 may have a plate shape.

The central hinge 1130 may be a configuration for connecting the first connection bracket 1120 and the second connection bracket 1150. The first connection bracket 1120 may be rotatable with respect to the second connection bracket 1150 about the central hinge 1130.

The base bracket 1140 may be located in front of the central hinge 1130. In addition, the base bracket 1140 may support a center of the panel assembly 110. A front surface of the base bracket 1140 may contact a rear surface of the panel assembly 110. At least a portion of the front surface of the base bracket 1140 may be coupled to at least a portion of the rear surface of the panel assembly 110.

The second connection bracket 1150 may be coupled to the second support bracket 1160. The second connection bracket 1150 may be thinner in a front-rear direction than the second support bracket 1160. The other end of the second connection bracket 1150 may be coupled to one end of the second support bracket 1160. The second connection bracket 1150 may extend to the right. One end of the second connection bracket 1150 may be coupled to the central hinge 1130. The second support bracket 1160 may have a plate shape. The second support bracket 1160 may have a similar shape to the first support bracket 1110.

The second support bracket 1160 may be a configuration for supporting the other side of the panel assembly 110. The second support bracket 1160 may be coupled to the one side of the panel assembly 110. An area of at least a portion of the second support bracket 1160 may be coupled to an area of at least a portion of the one side of the panel assembly 110. However, the present disclosure is not limited thereto.

A first inclined part 1111 may be formed on the other side of a front surface of the first support bracket 1110. In addition, a second inclined part 1161 may be formed on one side of a front surface of the second support bracket 1160. The first inclined part 1111 and the second inclined part 1161 may be chamfered parts. In addition, a third inclined part 1141 and a fourth inclined part 1142 may be formed on the other side and the one side of a rear surface of the base bracket 1140, respectively. The first inclined part, the second inclined part, the third inclined part, and the fourth inclined part may be a configuration for determining a maximum curvature of the panel assembly.

The radiation detector of FIG. 11 may borrow the configuration of the radiation detector of FIG. 10. For example, the radiation detector 100 of FIG. 11 may further comprise at least one of a first hinge 1020, an extendable and retractable first connection bracket 1030, a second hinge 1040, a third hinge 1060, an extendable and retractable second connection bracket 1070, and a fourth hinge 1080.

Generally, the bendable radiation detector images pipes for transporting large-scale pipelines such as gas and oil, as well as pipes for transporting heating and cooling, waste, and drinking water. A method for fixing the radiation detector to the pipe is performed by a method of tying using a bar or a rope, and in this situation, a physical force may be applied to the radiation detector. When a physical force is applied to the radiation detector, the external and internal structures of the radiation detector may be damaged. As a result, a problem may occur in that the radiation detector cannot be continuously used.

When the radiation detector 100 is not in close contact with the object 130 or shakes during imaging, the quality of the image is significantly degraded, and thus re-imaging may be required. In addition, when the radiation detector 100 cannot be fixed to the object 130, another method other than a physical method may be required to fix the radiation detector 100 to the object 130. Therefore, a pipe fixing method for fixing the radiation detector 100 is required according to the type, material, and structure of the object 130. Hereinafter, a method for fixing the radiation detector 100 to the object 130 will be described. The detector fixing assembly described below may be applied not only to a small radiation detector but also to a large radiation detector. In addition, a plurality of detector fixing assemblies described below may be implemented in combination with each other. Therefore, the present disclosure is not limited to the embodiments of the detector fixing assembly described below.

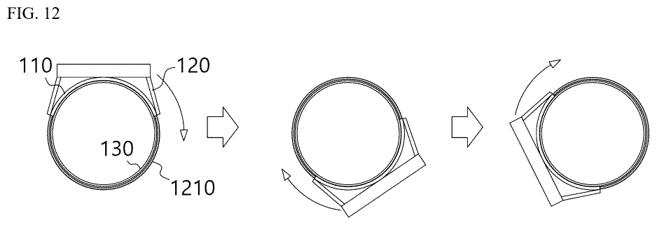

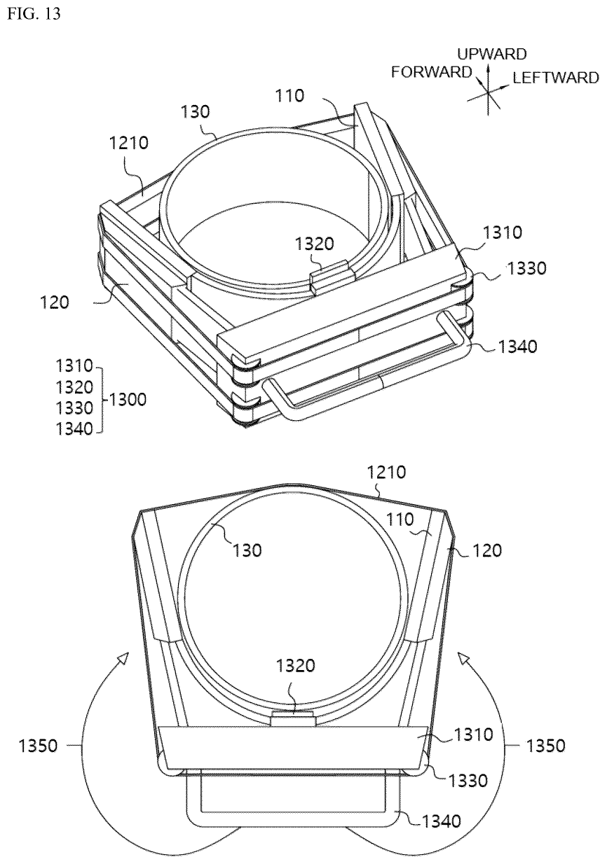

FIG. 12 is a view illustrating a use of a radiation detector according to an embodiment of the present disclosure.

Referring to FIG. 12, the radiation detector 100 for detecting radiation may image while rotating around the object 130. The object 130 may be an object having a curved surface, or a spherical or cylindrical object. For example, the object 130 may be a pipe. However, the present disclosure is not limited thereto, and the object 130 may be an object having a flat surface.

The radiation detector 100 may capture a radiation image while rotating around an outer circumferential surface of the object 130 to detect a crack in the pipe. Although not illustrated in FIG. 12, a source assembly for irradiating radiation may be located on an opposite side of the radiation detector 100.

Since the radiation detector 100 captures a radiation image in proximity to the object 130, the panel assembly 110 of the radiation detector 100 may be damaged by the object 130. However, the radiation detector 100 of the present disclosure may comprise a front protection part for protecting the radiation detector 100. Since the panel assembly 110 is not damaged by the front protection part, the performance of the radiation detector 100 may be maintained for a long period of time.

The radiation detector 100 may comprise the flexible panel assembly 110 extending in the first direction and detecting radiation incident on the first surface. The panel assembly 110 may be bent according to a shape of the object 130. Since the panel assembly 110 has already been described, an overlapping description thereof will be omitted.

The radiation detector 100 may comprise the bending support part 120 contacting the second surface opposite to the first surface of the radiation detection panel, supporting the panel assembly 110, and adjusting bending of the radiation detection panel about a bending axis parallel to the second direction intersecting the first direction.

A fixing band 1210 may be used for the radiation detector 100 to be fixed to the object 130. The fixing band 1210 may be directly coupled to the bending support part 120. However, the present disclosure is not limited thereto, and the fixing band 1210 may be fixed to a detector fixing assembly coupled to the bending support part 120. Since the fixing band 1210 may not be required depending on the site, the detector fixing assembly may be detachably implemented for weight reduction and miniaturization of the radiation detector 100. However, the present disclosure is not limited thereto.

The detector fixing assembly may allow the radiation detector 100 to maintain a predetermined distance from the object 130 having a flat or curved outer surface. Here, the predetermined distance may be 0 mm or more and 10 mm or less. However, the present disclosure is not limited thereto. At least a portion of the panel assembly 110 of the radiation detector 100 may contact the object 130. The predetermined distance between the radiation detector 100 and the object 130 may be 0 mm or more and 50 mm or less.

The radiation detector 100 may comprise a detector fixing assembly. The detector fixing assembly is detachably coupled to the bending support part 120 and may comprise a roller contacting the fixing band 1210 for coupling the radiation detector and the object or contacting the object. The fixing band 1210 may surround at least a portion of the object 130. The radiation detector 100 and the fixing band 1210 may surround the entire object 130.

Hereinafter, various embodiments of the detector fixing assembly will be described.

FIG. 13 is a view for explaining a detector fixing assembly according to an embodiment of the present disclosure.

The detector fixing assembly 1300 may comprise at least one of a detector fixing frame 1310, an assembly bracket 1320, a roller 1330, and a handle part 1340.

The detector fixing assembly 1300 may comprise the detector fixing frame 1310 forming a skeleton of the detector fixing assembly 1300 and coupled to the bending support part 120. The detector fixing frame 1310 may be coupled to at least a portion of a rear surface of the bending support part 120. The detector fixing frame 1310 may protect the bending support part 120 by surrounding at least a portion of the rear surface of the bending support part 120.

Although FIG. 13 describes the detector fixing frame 1310 as a different configuration from the bending support part 120, the detector fixing frame 1310 may be included in the bending support part 120. That is, the detector fixing assembly 1300 may be a configuration included in the bending support part 120. The detector fixing assembly 1300 may not be detachably coupled to the bending support part 120.

The assembly bracket 1320 may be located in at least one of an upward direction or a downward direction of the detector fixing frame 1310. The assembly bracket 1320 may be robustly fixed to the detector fixing frame 1310. The assembly bracket 1320 may comprise a friction pad on a front surface thereof for increasing friction with the object.

A front surface of the assembly bracket 1320 may be on the same plane as a front surface of the panel assembly 110, or may protrude in a forward direction from the front surface of the panel assembly 110. A front surface of the friction pad may be on the same plane as the front surface of the panel assembly 110, or may protrude in a forward direction from the front surface of the panel assembly 110. The assembly bracket 1320 included in the detector fixing assembly 1300 may protrude in a third direction by 0 mm or more and 50 mm or less from the front surface of the panel assembly 110. Here, the third direction may be a direction perpendicular to the first direction and the second direction. For example, the first direction may be a left direction, the second direction may be an upward direction, and the third direction may be a forward direction. The reason why the assembly bracket 1320 protrudes forward may be for the detector fixing assembly 1300 to absorb an impact applied to the radiation detector 100 by the object 130. Accordingly, the radiation detector may not be impacted, and high performance may be continuously maintained even in a harsh environment.

A material of the friction pad included in the assembly bracket 1320 may be a material for preventing the assembly bracket 1320 from sliding from the object 130. For example, the material of the friction pad may be a rubber-based, silicone-based, plastic-based, or urethane-based material.

The assembly bracket 1320 of the detector fixing assembly 1300 may comprise a suspension part. When the radiation detector 100 is imaging, impact energy applied to the radiation detector 100 or the object 130 may be absorbed by the suspension part. The suspension part of the plurality of detector fixing assemblies may comprise an elastic body. The suspension part may absorb a force applied in the front-rear direction. It has been described above that the assembly bracket 1320 may protrude in the third direction from the front surface of the panel assembly 110. At the time of imaging, the suspension part may be contracted, and at least a portion of the front surface of the panel assembly 110 may contact the object 130. Accordingly, the detector fixing assembly 1300 may absorb the impact applied to the radiation detector 100 and may not interfere with imaging.

The roller 1330 may be coupled to one side and the other side of the detector fixing frame 1310 to assist rotation of the fixing band 1210 with respect to the detector fixing assembly 1300. The fixing band 1210 may be wound along outer surfaces of the roller 1330 and the detector fixing frame 1310. However, the present disclosure is not limited thereto, and the fixing band 1210 may pass between the roller 1330 and the detector fixing frame 1310.

Guide protrusions protruding in a radial direction may be formed on an upper side and a lower side of the roller 1330. The fixing band 1210 may not be detached from the roller 1330 by the guide protrusions.

Although FIG. 13 illustrates a shape in which a part of the roller 1330 is inserted into the detector fixing frame 1310, the present disclosure is not limited thereto. The roller 1330 may be coupled to an axis extending in a direction substantially parallel to the second direction on an upper side surface and a lower side surface of the detector fixing frame 1310. The roller 1330 may not be a shape inserted into the detector fixing frame 1310. In the present disclosure, parallel may mean substantially parallel. For example, it may mean that extension directions differ by 15 degrees or less.

In addition, the handle part 1340 may be coupled to the rear surface of the detector fixing frame 1310. A user may perform the following process to capture a radiation image while rotating the radiation detector 100 around the object 130. As illustrated in FIG. 13, the fixing band 1210 may be formed to surround the object 130 and the detector fixing assembly 1300. The user may move the radiation detector 100 away from the object 130 by holding the handle part 1340 and then rotate 1350 the radiation detector 100 in order to move the radiation detector 100 with respect to the object 130. At this time, the fixing band 1210 may be fixed to the object 130 by friction. The roller 1330 may help the detector fixing assembly 1300 to easily rotate 1350 with respect to the fixing band 1210. Accordingly, the detector fixing assembly 1300 fixes the radiation detector 100 to the object 130 and, at the same time, allows the radiation detector 100 to be easily rotated along the outer circumferential surface of the object 130 by the roller 1330 for imaging.

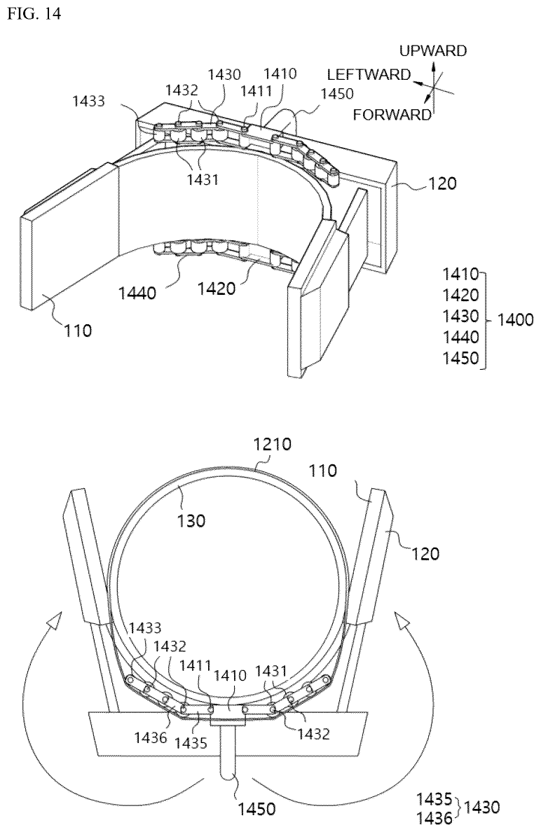

FIG. 14 is a view for explaining a detector fixing assembly according to an embodiment of the present disclosure.

The detector fixing assembly 1400 may comprise an upper assembly bracket 1410, a lower assembly bracket 1420, a first fixing arm 1430, a second fixing arm 1440, and a handle part 1450.

The upper assembly bracket 1410 may contact an upper side of the bending support part 120. The upper assembly bracket 1410 may be coupled to the upper side of the bending support part 120. The lower assembly bracket 1420 may contact a lower side of the bending support part 120. The lower assembly bracket 1420 may be coupled to the lower side of the bending support part 120. The description of the assembly bracket 1320 of FIG. 13 may be applied to the upper assembly bracket 1410 and the lower assembly bracket 1420. For example, the upper assembly bracket 1410 and the lower assembly bracket 1420 may comprise a friction pad and a suspension part.

One side of the first fixing arm 1430 may be rotatably coupled to the upper assembly bracket 1410 about a bracket axis 1411 extending substantially parallel to the second direction. Here, the second direction may mean an upward direction or a downward direction. One first fixing arm 1430 may be coupled to each of a left side and a right side of the upper assembly bracket 1410.

The first fixing arm 1430 may comprise a wheel axis 1432 extending substantially parallel to the second direction for allowing a roller 1431 to rotate. The first fixing arm 1430 may be coupled to a plurality of rollers 1431. Accordingly, the radiation detector 100 may be stably fixed to the object 130.

The first fixing arm 1430 may comprise a band axis 1433 on the other side thereof, to which the fixing band 1210 is coupled or which contacts a surface of the fixing band. For example, a hook formed on one side or the other side of the fixing band 1210 may be caught on the band axis 1433. In addition, the surface of the fixing band 1210 may contact the band axis 1433. A lower end of FIG. 14 illustrates a case where the surface of the fixing band 1210 contacts the band axis 1433.

The detector fixing assembly 1400 may use a plurality of fixing bands 1210. For example, one fixing band may surround an outside of the detector fixing assembly 1400 as illustrated in the lower end of FIG. 14. Hooks formed on one side and the other side of another fixing band may be caught on the band axis 1433. A plurality of fixing bands 1210 may be coupled to the first fixing arm 1430, and one fixing band 1210 may be fixed to the second fixing arm 1440. In addition, a plurality of fixing bands 1210 may be coupled to the second fixing arm 1440, and one fixing band may be fixed to the first fixing arm 1430. In addition, one of the plurality of fixing bands may be coupled to the first fixing arm 1430, and another fixing band may be coupled to the second fixing arm 1440.

The first fixing arm 1430 may comprise a base fixing arm 1435 and an extension fixing arm 1436. The base fixing arm 1435 and the extension fixing arm 1436 may be coupled by one wheel axis 1432 among a plurality of wheel axes. The extension fixing arm 1436 may rotate with respect to the base fixing arm 1435 about the wheel axis 1432. Accordingly, as illustrated in FIG. 14, the first fixing arm 1430 may have a bent shape. As such, the first fixing arm 1430 comprising the base fixing arm 1435 and the extension fixing arm 1436 or the roller coupled to the first fixing arm 1430 may be in close contact with the surface of the object 130 as much as possible. Accordingly, the radiation detector 100 may be robustly coupled to the object 130 by the fixing band 1210. In addition, the radiation detector 100 may be in close contact with the object 130 and easily rotate around the object 130.

The second fixing arm 1440 may have the same structure as the first fixing arm 1430. However, the second fixing arm 1440 may be different in that the second fixing arm 1440 is coupled to the lower assembly bracket 1420 and the first fixing arm 1430 is coupled to the upper assembly bracket 1410. Hereinafter, the second fixing arm 1440 will be briefly described.

One side of the second fixing arm 1440 may be rotatably coupled to the lower assembly bracket 1420 about a bracket axis extending substantially parallel to the second direction. The second fixing arm 1440 comprises a wheel axis extending substantially parallel to the second direction for allowing the roller to rotate. The second fixing arm 1440 may comprise a band axis on the other side thereof, to which the fixing band 1210 is coupled or which contacts a surface of the fixing band 1210.

The detector fixing assembly 1400 may comprise a handle part 1450 connecting the upper assembly bracket 1410 and the lower assembly bracket 1420. The user may easily move the radiation detector 100 with respect to the object 130 by holding the handle part 1450.

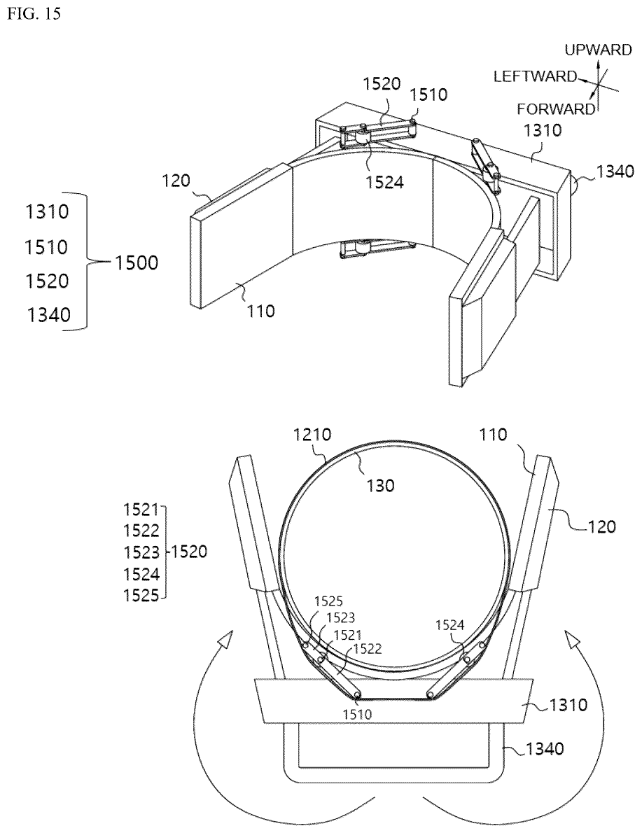

FIG. 15 is a view for explaining a detector fixing assembly according to an embodiment of the present disclosure.

The detector fixing assembly 1500 may comprise at least one of a detector fixing frame 1310, a bracket axis 1510, a fixing arm 1520, and a handle part 1340.

The detector fixing frame 1310 forms a skeleton of the detector fixing assembly 1500 and may be coupled to the bending support part 120. Since the detector fixing frame 1310 has already been described, an overlapping description thereof will be omitted.

The bracket axis 1510 may be coupled to the detector fixing frame 1310. The bracket axis 1510 may be coupled to an upper side or a lower side of the detector fixing frame 1310. The bracket axis 1510 may extend parallel to the second direction. The second direction may be an upward direction or a downward direction. At least one bracket axis 1510 may be formed on the upper side of the detector fixing frame 1310, and at least one bracket axis 1510 may be formed on the lower side of the detector fixing frame 1310. Accordingly, the detector fixing assembly 1500 may be in close contact with the object 130, and the radiation detector 100 may easily rotate around and image the object 130. In addition, the detector fixing assembly 1500 of the present disclosure is in close contact with the object 130, and thus may increase stability. That is, the detector fixing assembly 1500 may not shake with respect to the object 130.

The fixing arm 1520 may be rotatably coupled to the bracket axis 1510. In FIG. 15, one bracket axis 1510 is coupled to each fixing arm 1520. However, the present disclosure is not limited thereto. A plurality of fixing arms 1520 may be rotatably coupled to one bracket axis 1510. In addition, in FIG. 15, a plurality of bracket axes 1510 are formed on an upper end of the detector fixing frame 1310, and a plurality of bracket axes 1510 are formed on a lower end. However, the present disclosure is not limited thereto, and one bracket axis 1510 may be formed on the upper end of the detector fixing frame 1310, and one bracket axis 1510 may be formed on the lower end of the detector fixing frame 1310.

The fixing arm 1520 may comprise a wheel axis 1521 extending parallel to the second direction for allowing a roller 1524 to rotate. The fixing arm 1520 may comprise a band axis 1525 on the other side thereof, to which the fixing band 1210 is coupled or which contacts a surface of the fixing band 1210. For example, a hook formed on one side or the other side of the fixing band 1210 may be caught on the band axis 1525. In addition, the surface of the fixing band 1210 may contact the band axis 1525. A lower end of FIG. 15 illustrates a case where the surface of the fixing band 1210 contacts the band axis 1525.

The same description as that of the first fixing arm 1430 and the second fixing arm 1440 may be applied to the fixing arm 1520.

The fixing arm 1520 may comprise a base fixing arm 1522 and an extension fixing arm 1523.

The base fixing arm 1522 may be rotatably coupled to the bracket axis 1510. In addition, the extension fixing arm 1523 may be rotatably coupled to the base fixing arm 1522 about the wheel axis 1521. The extension fixing arm 1523 may comprise the band axis 1525 on the other side thereof, to which the fixing band 1210 is coupled or which contacts a surface of the fixing band 1210.

More specifically, the base fixing arm 1522 and the extension fixing arm 1523 may be coupled by the wheel axis 1521. The extension fixing arm 1523 may rotate with respect to the base fixing arm 1522 about the wheel axis 1521. Accordingly, as illustrated in FIG. 15, the fixing arm 1520 may have a bent shape. As such, the fixing arm 1520 comprising the base fixing arm 1522 and the extension fixing arm 1523 or the roller 1524 coupled to the fixing arm 1520 may be in close contact with the surface of the object 130 as much as possible. Accordingly, the radiation detector 100 may be robustly coupled to the object 130 by the fixing band 1210. In addition, the radiation detector 100 may be enabled to easily rotate around the object 130.

The detector fixing assembly 1500 may use a plurality of fixing bands 1210. For example, one fixing band may surround an outside of the detector fixing assembly 1500 as illustrated in the lower end of FIG. 15. Hooks formed on one side and the other side of another fixing band may be caught on the band axis 1525. A plurality of fixing bands 1210 may be coupled to the fixing arm 1520 located on an upper side of the detector fixing frame 1310, and one fixing band may be coupled to the fixing arm 1520 located on a lower side. In addition, a plurality of fixing bands 1210 may be coupled to the fixing arm 1520 located on the lower side of the detector fixing frame 1310, and one fixing band 1210 may be coupled to the fixing arm 1520 located on the upper side. In addition, one of the plurality of fixing bands may be coupled to the fixing arm 1520 located on the upper side, and another fixing band may be coupled to the fixing arm 1520 located on the lower side.

The handle part 1340 may be coupled to the rear surface of the detector fixing frame 1310. Since the handle part 1340 has already been described in FIG. 13, an overlapping description thereof will be omitted.

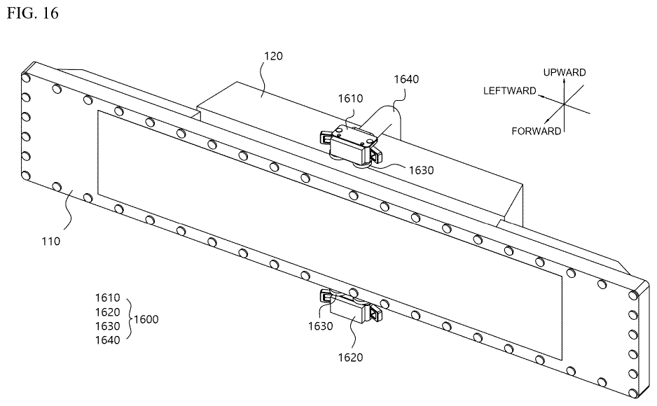

FIG. 16 is a view for explaining a detector fixing assembly according to an embodiment of the present disclosure.

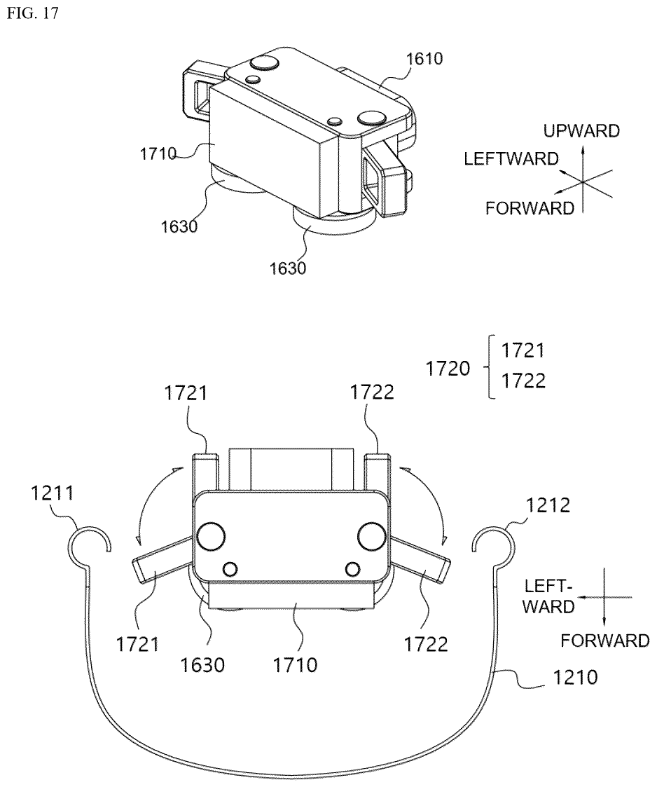

FIG. 17 is a view for explaining a part of a detector fixing assembly according to an embodiment of the present disclosure.

Referring to FIG. 16 and FIG. 17, the detector fixing assembly 1600 may comprise an upper assembly bracket 1610, a lower assembly bracket 1620, a roller 1630, and a handle part 1640.

The upper assembly bracket 1610 may contact an upper side of the bending support part 120. The upper assembly bracket 1610 may comprise a friction pad 1710 on a front surface thereof for increasing friction with the object 130.

The lower assembly bracket 1620 may contact a lower side of the bending support part. The lower assembly bracket 1620 may comprise a friction pad 1710 on a front surface thereof for increasing friction with the object 130. The friction pad 1710 may comprise at least one of an elastic body or a magnetic body.

The description of the assembly bracket 1320 of FIG. 13, and the upper assembly bracket 1410 and the lower assembly bracket 1420 of FIG. 14 may be applied to the upper assembly bracket 1610 and the lower assembly bracket 1620.

More specifically, front surfaces of the upper assembly bracket 1610 and the lower assembly bracket 1620 may be on the same plane as the front surface of the panel assembly 110, or may protrude in a forward direction from the front surface of the panel assembly 110. A front surface of the friction pad 1710 may be on the same plane as the front surface of the panel assembly 110, or may protrude in a forward direction from the front surface of the panel assembly 110. The upper assembly bracket 1610 and the lower assembly bracket 1620 included in the detector fixing assembly 1600 may protrude in a third direction by 0 mm or more and 50 mm or less from the front surface of the panel assembly 110. Here, the third direction may be a direction perpendicular to the first direction and the second direction. For example, the first direction may be a left direction, the second direction may be an upward direction, and the third direction may be a forward direction. The reason why the upper assembly bracket 1610 and the lower assembly bracket 1620 protrude forward may be for the detector fixing assembly 1600 to absorb an impact applied to the radiation detector 100 by the object 130. Accordingly, the radiation detector may not be impacted, and high performance may be continuously maintained even in a harsh environment.

A material of the friction pad 1710 included in the upper assembly bracket 1610 and the lower assembly bracket 1620 may be a material for preventing the upper assembly bracket 1610 and the lower assembly bracket 1620 from sliding from the object 130. For example, the material of the friction pad 1710 may be a rubber-based, silicone-based, plastic-based, or urethane-based material. In addition, the material of the friction pad 1710 may be magnetic.

The upper assembly bracket 1610 and the lower assembly bracket 1620 of the detector fixing assembly 1600 may comprise a suspension part. When the radiation detector 100 is imaging, impact energy applied to the radiation detector 100 or the object 130 may be absorbed by the suspension part. The suspension part of the plurality of detector fixing assemblies may comprise an elastic body. The suspension part may absorb a force applied in the front-rear direction. It has been described above that the upper assembly bracket 1610 and the lower assembly bracket 1620 may protrude in the third direction from the front surface of the panel assembly 110. At the time of imaging, the suspension part may be contracted, and at least a portion of the front surface of the panel assembly 110 may contact the object 130. That is, at the time of imaging, the front surface of the friction pad 1710 may be on substantially the same plane as the front surface of the panel assembly 110. Accordingly, the detector fixing assembly 1600 may absorb the impact applied to the radiation detector 100 and may not interfere with imaging.

The roller 1630 may contact an outer circumferential surface of the object 130, and may be rotatable about an axis parallel to the second direction. The roller 1630 may be coupled to at least one of the upper assembly bracket 1610 and the lower assembly bracket 1620.

The roller 1630 included in the detector fixing assembly 1600 may protrude in the third direction by 0 mm or more and 50 mm or less from the panel assembly 110. The roller 1630 included in the detector fixing assembly may protrude in the third direction by 0 mm or more and 5 mm or less from the front surface of the panel assembly 110. That the roller 1630 protrudes by 0 mm in the third direction from the front surface of the panel assembly 110 may mean that the roller 1630 contacts a plane parallel to the front surface of the panel assembly 110.

A suspension part may be formed between the roller 1630 and at least one of the upper assembly bracket 1610 and the lower assembly bracket 1620. Since the suspension part has already been described, a detailed description thereof will be omitted. At the time of imaging, the roller 1630 may contact the object 130. In addition, when the radiation detector 100 rotates along the outer circumferential surface of the object 130, the roller 1630 may rotate while contacting the object 130.

A diameter of the roller 1630 included in the detector fixing assembly 1600 may be 100 mm or less. However, the present disclosure is not limited thereto. A material of the roller 1630 may be a material for preventing the roller 1630 from sliding from the object 130. For example, the material of the roller 1630 may be a rubber-based or urethane-based material.

A roller rotation axis included in the detector fixing assembly 1600 may be parallel to the second direction. That is, the roller rotation axis may extend in a direction parallel to the second direction. The roller rotation axis may be a rotation center of the roller 1630. The roller rotation axis may connect the roller 1630 to at least one of the upper assembly bracket 1610 and the lower assembly bracket 1620. The roller rotation axis may be fixed to the upper assembly bracket 1610 and the lower assembly bracket 1620 and may not rotate. However, the present disclosure is not limited thereto, and the roller rotation axis may be connected to the upper assembly bracket 1610 and the lower assembly bracket 1620 and rotate together with the roller 1630.

The detector fixing assembly 1600 may comprise a plurality of rollers 1630. However, the present disclosure is not limited thereto, and one detector fixing assembly 1600 may comprise one roller 1630.

An attractive force may act between the detector fixing assembly 1600 and the outer circumferential surface of the object. For example, the detector fixing assembly 1600 may further comprise a fixing magnet having magnetism in the region of the friction pad 1710. The detector fixing assembly 1600 may comprise at least one of the friction pad 1710 and the fixing magnet. In addition, the detector fixing assembly 1600 may comprise a roller 1630 having magnetism. Accordingly, the object 130 made of a material that is attracted by the magnet may be pulled by the detector fixing assembly 1600. Thereby, a distance between the radiation detector 100 and the object 130 may be minimized. In addition, the radiation detector 100 may be fixed to the object 130 by friction between the detector fixing assembly 1600 and the object 130.

As such, the radiation detector 100 may conveniently obtain a radiation image while moving around the object 130, and a distance between the panel assembly 110 of the radiation detector 100 and the object 130 is minimized, and thus the radiation detector 100 may obtain a high-quality image of the object 130, and may increase user's convenience. This is because, when the detector fixing assembly 1600 is not present, the user must repeat a process of fixing the radiation detector 100 at a specific position of the object 130, imaging, detaching the radiation detector 100 from the object 130, and fixing the radiation detector 100 at another position of the object 130 again.

The radiation detector 100 may leave a scratch on the surface of the object 130. However, the radiation detector 100 of the present disclosure may prevent the radiation detector 100 from contacting or slightly contacting the object 130 by one of the roller 1630 or the friction pad 1710 included in the detector fixing assembly 1600. Accordingly, the surface of the object 130 may be protected from the radiation detector 100.

In addition, since the radiation detector 100 rotates around the object 130 in proximity to the object 130, the radiation detector 100 may be scratched by the object 130. In particular, the panel assembly 110 approaching the object 130 may be scratched. The panel assembly 110 may be protected by the panel protection part, but in addition, the panel assembly 110 may be prevented from being scratched by the front protection part. The front protection part may be detachable from the front surface of the radiation detector 100. However, the present disclosure is not limited thereto, and the front protection part may be a fixed type. In addition, the radiation detector 100 may comprise at least one of the panel protection part and the front protection part. In addition,

the radiation detector 100 of the present disclosure may prevent the radiation detector 100 from being scratched by the object 130 by preventing the radiation detector 100 from contacting or slightly contacting the object 130 by one of the roller 1630 or the friction pad 1710 included in the detector fixing assembly 1600. The radiation detector 100 of the present disclosure may prevent the panel assembly 110 from being scratched to maintain high quality of the radiation image.

The detector fixing assembly 1600 may comprise a suspension part. Accordingly, when the detector fixing assembly 1600 rotates around the object 130, impact energy applied to the radiation detector 100 or the object 130 may be absorbed by the suspension part. The suspension part of the detector fixing assembly may be formed in a region where the radiation detector 100 and the detector fixing assembly are coupled. The suspension part may be included in at least one of the upper assembly bracket 1610 and the lower assembly bracket 1620. The suspension part may be formed in a region where the friction pad 1710 is coupled to at least one of the upper assembly bracket 1610 and the lower assembly bracket 1620. In addition, the suspension part may be formed in a region where the roller 1630 is coupled to at least one of the upper assembly bracket 1610 and the lower assembly bracket 1620. The suspension part of the detector fixing assembly may comprise an elastic body. The suspension part may absorb a force applied in the front-rear direction.

The detector fixing assembly 1600 may allow the radiation detector 100 to move along the outer circumferential surface of the object. In addition, the detector fixing assembly may comprise a rotatable roller 1630. More specifically, the roller 1630 included in the detector fixing assembly may rotate about the roller rotation axis. The roller rotation axis may be parallel to the second direction. The second direction may be one of an upward direction or a downward direction.

An attractive force may act between the fixing magnet and the outer circumferential surface of the object. For example, the fixing magnet may comprise a magnet. The magnet may be disposed toward a front side of the fixing magnet. The fixing magnet may contact the object and fix the radiation detector 100 to the object 130 by friction. The fixing magnet may have one of a rectangular parallelepiped shape, a cylindrical shape, and a spherical shape. The fixing magnet may have one of a rectangular parallelepiped shape, a cylindrical shape, and a spherical shape. However, the present disclosure is not limited thereto. The fixing magnet may be replaceable with a shape suitable for the object. Accordingly, the radiation detector 100 may be applicable to any object 130.

The handle part 1640 may be a configuration connecting the upper assembly bracket 1610 and the lower assembly bracket 1620. Since the handle part 1640 has already been described, an overlapping description thereof will be omitted.

Referring to FIG. 17, the detector fixing assembly 1600 may comprise a strap bracket 1720. The strap bracket 1720 may be formed on at least one of the upper assembly bracket 1610 and the lower assembly bracket 1620. The strap bracket 1721 may be formed on one side of at least one of the upper assembly bracket 1610 and the lower assembly bracket 1620. In addition, the strap bracket 1722 may be formed on the other side of at least one of the upper assembly bracket 1610 and the lower assembly bracket 1620. The strap bracket 1720 may be a configuration for connecting the fixing band 1210. A hook formed on one end or the other end of the fixing band 1210 may be caught on the strap bracket 1720. A hook 1211 on one side of the fixing band 1210 is caught on the strap bracket 1721 on the one side, and a hook 1212 on the other side of the fixing band 1210 is caught on the strap bracket 1722 on the other side, such that the fixing band 1210 may surround the object 130.

The strap bracket 1720 may be rotatable about an axis extending parallel to the second direction. The second direction may be an upward direction. The strap bracket 1720 may be fixed in a predetermined position by a strap bracket fixing part (not illustrated). For example, at least one of the strap brackets 1721 and 1722 on the one side and the other side may be folded. When at least one of the strap brackets 1721 and 1722 on the one side and the other side is folded, it may be easy to store the radiation detector 100. For example, at least one of the strap brackets 1721 and 1722 on the one side and the other side may be unfolded. When at least one of the strap brackets 1721 and 1722 on the one side and the other side is unfolded, it may be convenient to couple the fixing band 1210 to the strap brackets 1721 and 1722. The strap bracket fixing part may be implemented by a ball plunger. The strap bracket 1720 may be unfolded step by step or folded step by step by the strap bracket fixing part. However, the present disclosure is not limited thereto.

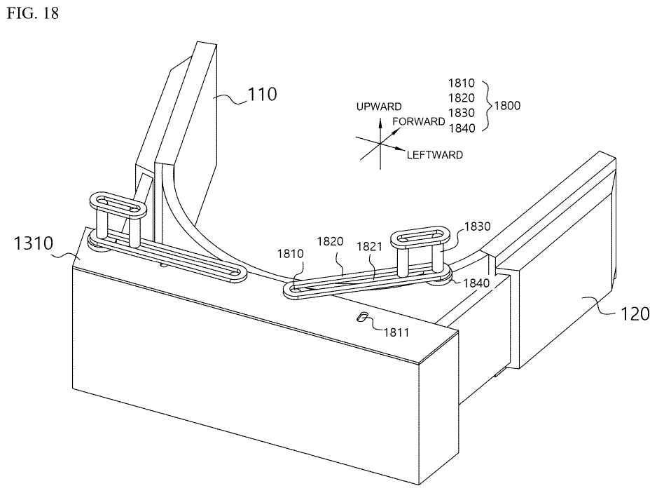

FIG. 18 is a view for explaining a detector fixing assembly according to an embodiment of the present disclosure.

The detector fixing assembly 1800 may comprise at least one of a detector fixing frame 1310, a bracket axis 1810, a fixing arm 1820, and a band axis 1830.

The detector fixing frame 1310 may be a configuration forming a skeleton of the detector fixing assembly 1800 and coupled to the bending support part 120. Since the detector fixing frame 1310 has already been described with reference to FIG. 13, an overlapping description thereof will be omitted.

The bracket axis 1810 may be coupled to the detector fixing frame 1310. The bracket axis 1810 may extend parallel to the second direction. The description of the bracket axis 1411 of FIG. 14 or the bracket axis 1510 of FIG. 15 may be applied to the description of the bracket axis 1810. Accordingly, an overlapping description will be omitted.

One side of the fixing arm 1820 may be rotatably coupled to the bracket axis 1810. Since the fixing arm 1820 is rotatable about the bracket axis 1810, the fixing arm 1820 may approach the outer circumferential surface of the object 130 as much as possible. The fixing arm 1820 may help the radiation detector 100 to be in close contact with the object 130. Accordingly, the radiation detector 100 may acquire a high-quality radiation image.

The fixing arm 1820 may comprise at least one band axis 1830 on the other side thereof, to which the fixing band 1210 is coupled or which contacts a surface of the fixing band 1210. The fixing arm 1820 may be coupled to at least one band axis 1830 on the other side thereof, to which the fixing band 1210 is coupled or which contacts a surface of the fixing band 1210. An extension direction of the fixing arm 1820 and an extension direction of the band axis 1830 may be perpendicular to each other. A guide groove 1821 may be formed along a longitudinal direction of the fixing arm 1820. The band axis 1830 may move along the guide groove 1821. However, the present disclosure is not limited thereto.

Hooks formed on one side and the other side of the fixing band 1210 may be coupled to the band axis 1830. There may be a plurality of band axes 1830. The fixing band 1210 may surround the object 130 by 360 degrees or more by the band axis 1830. For example, after one side of the fixing band 1210 is fixed to the left band axis 1830 of FIG. 18, the fixing band 1210 may extend in a rightward direction to surround the object 130, and then the other side of the fixing band 1210 may be fixed to the right band axis 1830 of FIG. 18.

A roller 1840 may be formed on the other side of the fixing arm 1820. At the time of imaging or when the radiation detector 100 rotates along the outer circumferential surface of the object 130, the roller 1840 may contact the object 130. The roller 1840 may prevent the fixing arm 1820 from contacting the object 130, thereby preventing the object 130 from being damaged by the fixing arm 1820.

A fixing protrusion (not illustrated) may be formed on a lower side of the fixing arm 1820. The fixing protrusion may be a ball plunger. However, the present disclosure is not limited thereto. In addition, a fixing groove 1811 may be formed on an upper side of the detector fixing frame 1310. The fixing arm 1820 may be fixed to the detector fixing frame 1310 by coupling of the fixing protrusion and the fixing groove 1811. It may be cumbersome if the fixing arm 1820 rotates about the bracket axis 1810 when storing or moving the radiation detector 100. Accordingly, when moving or storing, the fixing arm 1820 may be fixed to the detector fixing frame 1310 by the coupling of the fixing protrusion and the fixing groove 1811.

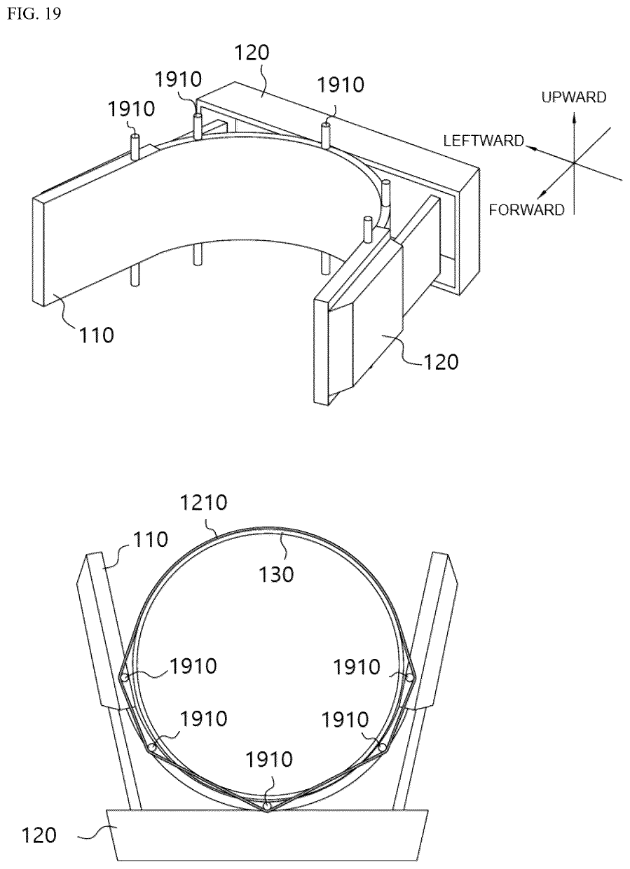

### FIG. 19 is a view for explaining a radiation detector according to an embodiment of the present disclosure.

The radiation detector 100 of the present disclosure may comprise a flexible panel assembly 110 extending in a first direction and detecting radiation incident on a first surface. In addition, the radiation detector 100 of the present disclosure may comprise a bending support part 120 coupled to the panel assembly 110 and supporting the panel assembly 110, and adjusting bending of the panel assembly about at least one bending axis parallel to a second direction.

The radiation detector 100 may comprise a plurality of band axes 1910. The plurality of band axes 1910 may be coupled to an upward direction and a downward direction of the bending support part 120. The band axes 1910 may be coupled to the bending support part 120 at predetermined intervals along a longitudinal direction of the bending support part 120. The band axis 1910 may be rotatable with respect to the bending support part 120 about an axis parallel to the upward direction. As illustrated in a lower end of FIG. 19, a surface of the fixing band 1210 may contact the band axis 1910. In addition, when the radiation detector 100 rotates along the outer circumferential surface of the object 130, the band axis 1910 may allow the radiation detector 100 to easily rotate without being affected by the fixing band 1210.

Although not illustrated in FIG. 19, a roller may be formed on at least one of the band axes 1910.

The radiation detector of FIG. 19 may be convenient because it is not necessary to couple a separate detector fixing assembly to the radiation detector 100.

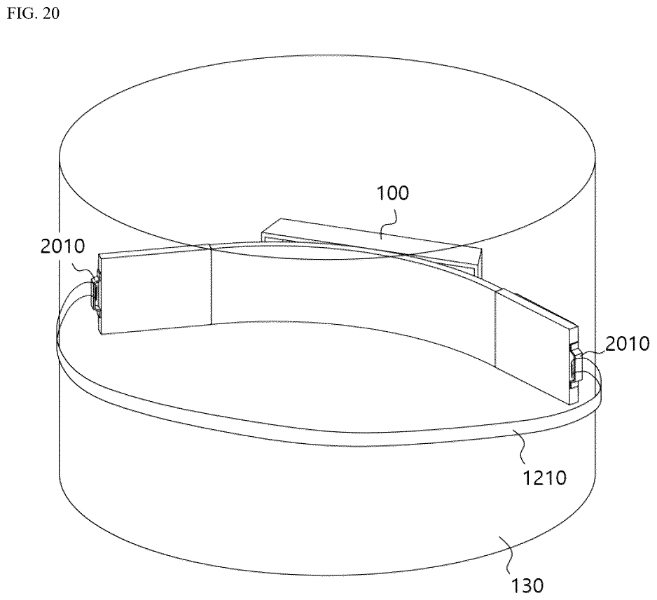

FIG. 20 is a view for explaining a radiation detector according to an embodiment of the present disclosure.

Referring to FIG. 20, strap brackets 2010 may be formed on a left side and a right side of the radiation detector 100. The strap bracket 2010 may have a shape on which a hook may be caught. The strap bracket 2010 may be a configuration for connecting the fixing band 1210. A hook formed on one end or the other end of the fixing band 1210 may be caught on the strap bracket 2010. A hook on one side of the fixing band 1210 is caught on the strap bracket 2010 on one side, and a hook on the other side of the fixing band 1210 is caught on the strap bracket 2010 on the other side, such that the fixing band 1210 may surround the object 130.

As described above, the method for fixing the radiation detector 100 to the object 130 has been described. The above embodiments may be implemented in combination with each other. In addition, the detector fixing assemblies according to the plurality of embodiments described above may be implemented in combination with each other.

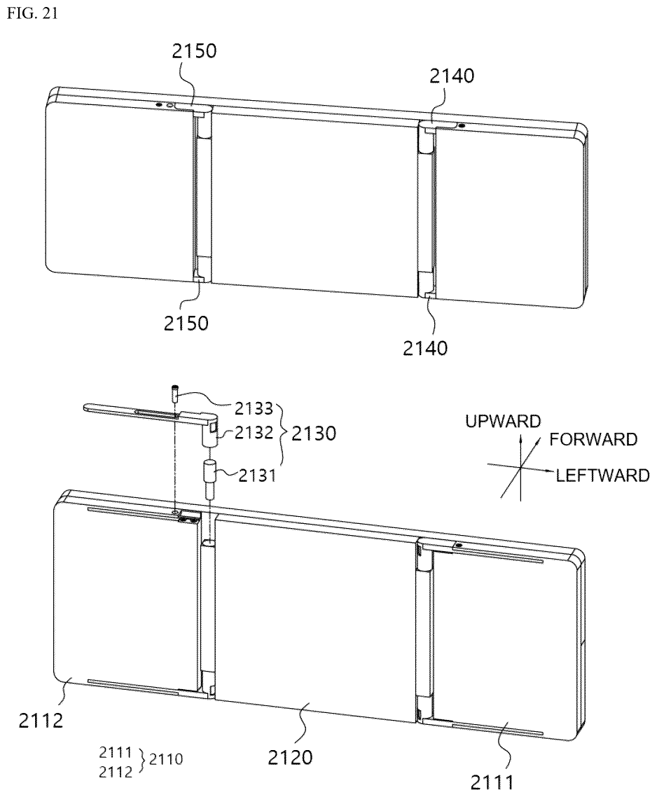

FIG. 21 illustrates a radiation detector according to an embodiment of the present disclosure.

FIG. 21 is a perspective view of the radiation detector viewed from behind.

The radiation detector 100 may comprise a flexible panel assembly 110 extending in a first direction and detecting radiation incident on a first surface. The radiation detector 100 may comprise a bending support part 120 coupled to the panel assembly and supporting the panel assembly, and adjusting bending of the panel assembly about at least one bending axis parallel to a second direction. Since the panel assembly 110 and the bending support part 120 have already been described, an overlapping description thereof will be omitted.

The bending support part 120 may comprise a side rear cover 2110, a central rear cover 2120, and a torque providing part 2130.

The side rear cover 2110 may be located in a direction opposite to a third direction of at least one of one side or the other side of the panel assembly 110. The third direction may be a forward direction. The central rear cover 2120 may be located on one of one side or the other side of the side rear cover 2110. The torque providing part 2130 may be fixed to the central rear cover 2120 for providing torque to the side rear cover 2110.

More specifically, the bending support part 120 may comprise a one-side rear cover 2111 located in a direction opposite to the third direction of one side of the panel assembly 110. In addition, the bending support part 120 may comprise the-other-side rear cover 2112 located in a direction opposite to the third direction of the other side of the panel assembly 110. In addition, the bending support part 120 may comprise the central rear cover 2120 located between the one-side rear cover 2111 and the-other-side rear cover 2112 and rotatably coupled to the one-side rear cover 2111 and the-other-side rear cover 2112.

In addition, the bending support part 120 may comprise a one-side torque providing part 2140 for rotatably coupling the one-side rear cover 2111 and the central rear cover 2120. In addition, the bending support part 120 may comprise the-other-side torque providing part 2150 for rotatably coupling the-other-side rear cover 2112 and the central rear cover 2120.

The one-side torque providing part 2140 and the-other-side torque providing part 2150 may have the same structure. Accordingly, hereinafter, the torque providing part 2130 will be mainly described.

The torque providing part 2130 may comprise at least one of a torque hinge 2131 and a guide bracket 2132. The torque providing part 2130 may comprise at least one of a torque hinge 2131, a guide bracket 2132, and a rear cover fixing bolt 2133.

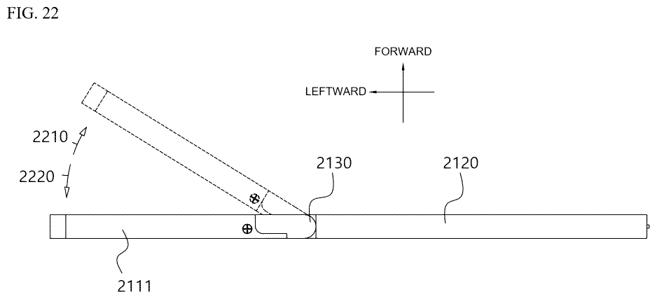

The torque hinge 2131 is fixed to the central rear cover 2120 and may extend parallel to the second direction. The torque hinge 2131 may provide torque in a direction in which the side rear cover 2110 folds with respect to the central rear cover 2120 about an axis parallel to the second direction. Hereinafter, FIG. 22 will be temporarily referred to in order to describe the torque hinge 2131.

FIG. 22 is a view for explaining a torque hinge according to an embodiment of the present disclosure.

The torque hinge 2131 included in the torque providing part 2130 may provide torque in a direction 2210 in which the side rear cover 2110 folds. A state in which the side rear cover 2110 is folded with respect to the central rear cover 2120 may be maintained by the torque hinge 2131. In addition, a state in which the side rear cover 2110 is unfolded with respect to the central rear cover 2120 may be maintained by the torque hinge 2131. Here, the folded state may mean that an angle formed by a surface of the central rear cover 2120 and a surface of the side rear cover 2110 is smaller than 180 degrees. In addition, the unfolded state indicates that an angle formed by the surface of the central rear cover 2120 and the surface of the side rear cover 2110 is substantially 180 degrees. According to the radiation detector 100 of the present disclosure, the radiation detector 100 may be in close contact with the object even if the user does not apply a force. In addition, the panel assembly 110 may be bent as the side rear cover 2110 folds with respect to the central rear cover 2120.

The torque hinge 2131 included in the torque providing part 2130 may not provide torque in a direction 2220 opposite to the direction in which the side rear cover 2110 folds. However, the present disclosure is not limited thereto. The torque hinge 2131 may also provide torque in the direction 2220 opposite to the direction in which the side rear cover 2110 folds. A state in which the side rear cover 2110 is folded with respect to the central rear cover 2120 may be maintained by the torque hinge 2131. For example, the radiation detector 100 may maintain a folded or unfolded state by equilibrium of forces by the torque hinge 2131. Accordingly, the radiation detector 100 may be in close contact with the object even if the user does not apply a force.

According to various embodiments of the present disclosure, the torque hinge 2131 may comprise a damper hinge, a one-way torque hinge, or a two-way torque hinge.

Referring again to FIG. 21, the guide bracket 2132 may be coupled to the torque hinge 2131. At least a portion of the guide bracket 2132 may extend parallel to the first direction. A portion of the guide bracket 2132 extending parallel to the first direction may be inserted into at least a portion of a guide hole formed in a surface of the side rear cover 2110 in the second direction or a surface in a direction opposite to the second direction. Accordingly, the torque generated in the torque hinge 2131 may be transmitted to the side rear cover 2110.

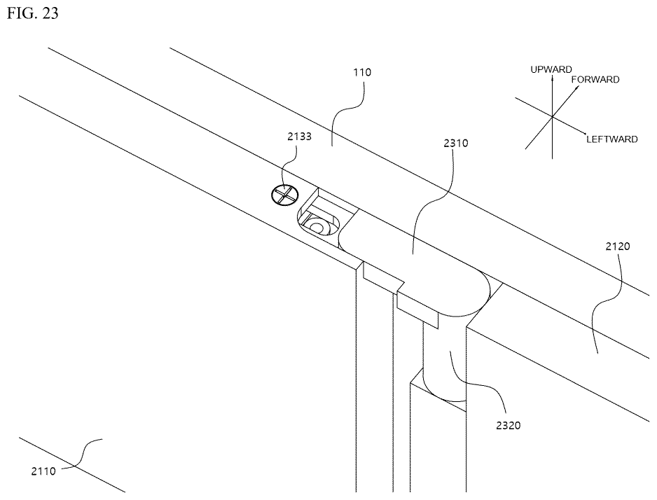

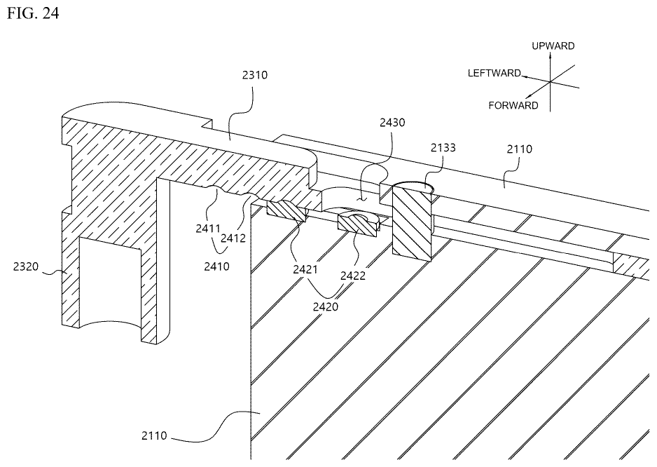

Hereinafter, the guide bracket 2132 will be described in more detail with reference to FIG. 23.

FIG. 23 illustrates a part of a radiation detector according to an embodiment of the present disclosure.

The guide bracket 2132 may comprise a guide bracket coupling part 2320 and a guide bracket rod 2310. The guide bracket coupling part 2320 and the guide bracket rod 2310 may be integrally formed. However, the present disclosure is not limited thereto.

The guide bracket coupling part 2320 may be coupled to the torque hinge 2131. A part of the torque hinge 2131 may be rotatable with respect to the central rear cover 2120. The guide bracket coupling part 2320 may also be rotatable with respect to the central rear cover 2120.

The guide bracket coupling part 2320 may have a cylindrical shape extending parallel to the second direction. The guide bracket coupling part 2320 having a cylindrical shape may comprise a torque hinge receiving part 2620 for receiving the torque hinge 2131. The torque hinge receiving part 2620 may surround at least a portion of the torque hinge 2131.

The guide bracket coupling part 2320 may be fixed to at least a portion of the torque hinge 2131 and be a configuration for transmitting rotational force generated from the torque hinge 2131 to the side rear cover 2110.

The guide bracket rod 2310 may be coupled to the guide bracket coupling part 2320. The guide bracket rod 2310 extends parallel to the first direction, and at least a portion thereof may be inserted into a guide hole formed in the side rear cover 2110. The torque generated from the torque hinge 2131 may be transmitted to the side rear cover 2110 by the guide bracket rod 2310.

FIG. 24 will be further referred to in order to describe the guide bracket rod 2310.

FIG. 24 is a view for explaining a guide bracket rod according to an embodiment of the present disclosure.

A guide bracket groove 2410 may be formed in a surface of the guide bracket rod 2310 in a direction opposite to the second direction. The surface in the direction opposite to the second direction may be a lower surface. At least one guide bracket groove 2410 may be formed. For example, the guide bracket rod 2310 may comprise a first guide bracket groove 2411 and a second guide bracket groove 2412.

In addition, a guide bracket elongated hole 2430 may be formed in the guide bracket rod 2310. The guide bracket elongated hole 2430 may extend in a longitudinal direction of the guide bracket rod 2310. The guide bracket elongated hole 2430 may be located farther from the central rear cover 2120 than the guide bracket groove 2410.

The side rear cover 2110 may comprise a rear cover fixing bolt 2133 extending parallel to the second direction, passing through the guide bracket elongated hole 2430, and fixed to the side rear cover 2110. The rear cover fixing bolt 2133 may pass through an upper side surface of the side rear cover 2110, be formed in the side rear cover 2110, and pass through the guide hole and the guide bracket elongated hole 2430.

The rear cover fixing bolt 2133 may be a configuration for guiding or limiting movement of the guide bracket rod 2310. As described above, the guide bracket rod 2310 may be inserted into the guide hole formed in the side rear cover 2110. The guide bracket rod 2310 may move only in the first direction and a direction opposite to the first direction by the guide hole formed in the side rear cover 2110. That is, the guide bracket rod 2310 may move along an extension direction of the guide hole. In addition, the guide bracket rod 2310 may move only in the first direction and the direction opposite to the first direction by the rear cover fixing bolt 2133 inserted into the guide bracket elongated hole 2430. In addition, the rear cover fixing bolt 2133 may move within the guide bracket elongated hole 2430 along an extension direction of the guide bracket elongated hole 2430.

In addition, movement of the guide bracket rod 2310 may be limited by the rear cover fixing bolt 2133. For example, the rear cover fixing bolt 2133 may move only from one side to the other side of the guide bracket elongated hole 2430, and accordingly, the movement of the guide bracket rod 2310 may be limited.

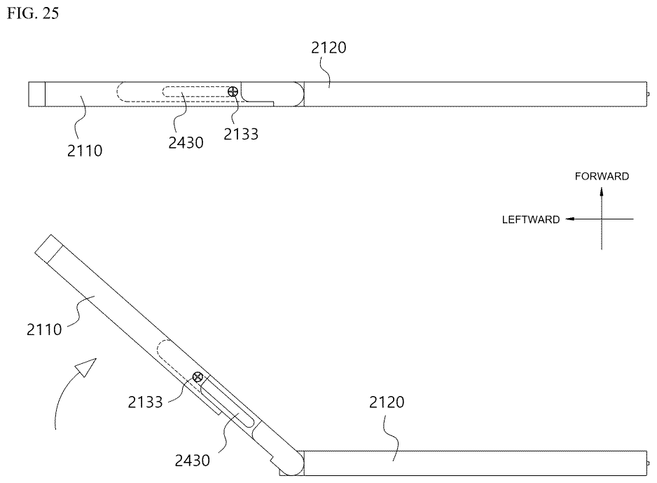

FIG. 25 will be referred to in order to describe movement of the rear cover fixing bolt 2133 with respect to the guide bracket rod 2310.

FIG. 25 is a view for explaining a torque providing part according to an embodiment of the present disclosure.

The rear cover fixing bolt 2133 may move farther from the central rear cover 2120 as the side rear cover 2110 folds with respect to the central rear cover 2120. That is, the rear cover fixing bolt 2133 may move to the other side of the guide bracket elongated hole 2430 as the side rear cover 2110 folds with respect to the central rear cover 2120. Here, that the side rear cover 2110 folds with respect to the central rear cover 2120 may mean that the radiation detector 100 is bent. When the rear cover fixing bolt 2133 reaches an end of the other side of the guide bracket elongated hole 2430, the radiation detector 100 may no longer be bent. Accordingly, the rear cover fixing bolt 2133 and the guide bracket elongated hole 2430 may be used as a structure for limiting bending of the radiation detector 100.

When the rear cover fixing bolt 2133 reaches the end of the other side of the guide bracket elongated hole 2430, the rear cover fixing bolt 2133 may prevent the guide bracket rod 2310 from moving any more with respect to the side rear cover 2110, thereby preventing the guide bracket rod 2310 from being detached from the guide hole formed in the side rear cover 2110.

In addition, the rear cover fixing bolt 2133 may move closer to the central rear cover 2120 as the side rear cover 2110 unfolds with respect to the central rear cover 2120. That is, the rear cover fixing bolt 2133 may move to one side of the guide bracket elongated hole 2430 as the side rear cover 2110 unfolds with respect to the central rear cover 2120. Here, that the side rear cover 2110 unfolds with respect to the central rear cover 2120 may mean that the radiation detector 100 is unfolded.

Referring again to FIG. 24, the guide bracket groove 2410 may be formed in the surface of the guide bracket rod 2310 in the direction opposite to the second direction. As described above, the guide bracket rod 2310 may comprise at least one guide bracket groove 2410. The guide bracket groove 2410 may comprise the first guide bracket groove 2411 and the second guide bracket groove 2412.

In addition, the side rear cover 2110 may comprise a rear cover fixing protrusion 2420 convex in the second direction. The side rear cover 2110 may comprise at least one rear cover fixing protrusion 2420. For example, the rear cover fixing protrusion 2420 may comprise a first rear cover fixing protrusion 2421 and a second rear cover fixing protrusion 2422.

The rear cover fixing protrusion 2420 may be detached from the guide bracket groove 2410 when the side rear cover 2110 is folded with respect to the central rear cover 2120. That is, the rear cover fixing protrusion 2420 may move to the other side from the central rear cover 2120 as the side rear cover 2110 folds with respect to the central rear cover 2120. The rear cover fixing protrusion 2420 may move away from the guide bracket groove 2410 as the side rear cover 2110 folds with respect to the central rear cover 2120. Here, that the side rear cover 2110 folds with respect to the central rear cover 2120 may mean that the radiation detector 100 is bent. The rear cover fixing protrusion 2420 detached from the guide bracket groove 2410 may be located at a lower end of the guide bracket elongated hole 2430. The rear cover fixing protrusion 2420 may be inserted into the guide bracket elongated hole 2430 and guide the movement of the guide bracket rod 2310.

When the side rear cover 2110 is unfolded with respect to the central rear cover 2120, the rear cover fixing protrusion 2420 may be coupled to the guide bracket groove 2410. That is, the rear cover fixing protrusion 2420 may move to one side from the central rear cover 2120 as the side rear cover 2110 unfolds with respect to the central rear cover 2120. The rear cover fixing protrusion 2420 may move closer to the guide bracket groove 2410 as the side rear cover 2110 unfolds with respect to the central rear cover 2120.

The unfolded state of the radiation detector 100 may be maintained by the rear cover fixing protrusion 2420 and the guide bracket groove 2410. The torque providing part 2130 may provide torque in a direction in which the radiation detector 100 folds. Accordingly, unless the user applies a force, the folded state of the radiation detector 100 may be maintained. However, when the rear cover fixing protrusion 2420 is inserted into the guide bracket groove 2410, the unfolded state of the radiation detector 100 may be maintained by friction.

The radiation detector 100 may be unfolded step by step or folded step by step by the plurality of rear cover fixing protrusions 2420 and the plurality of guide bracket grooves 2410. Referring to FIG. 24, when the radiation detector 100 is fully unfolded, the first rear cover fixing protrusion 2421 is inserted into the first guide bracket groove 2411, and the second rear cover fixing protrusion 2422 is inserted into the second guide bracket groove 2412, such that the unfolded state may be maintained. In addition, when the radiation detector 100 is slightly folded, the first rear cover fixing protrusion 2421 may be inserted into the second guide bracket groove 2412, such that the slightly folded state may be maintained. When the radiation detector 100 is fully folded, both the first rear cover fixing protrusion 2421 and the second rear cover fixing protrusion 2422 may be detached from the first guide bracket groove 2411 and the second guide bracket groove 2412.

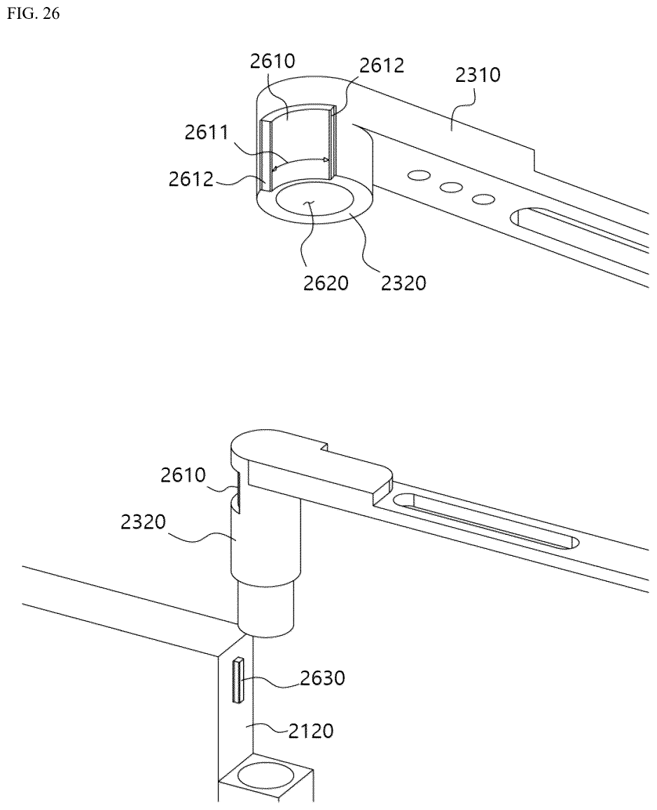

FIG. 26 is a view for explaining a guide bracket according to an embodiment of the present disclosure.

A rotation limit groove 2610 may be formed in an outer circumferential surface of the guide bracket coupling part 2320. A rotation range of the side rear cover 2110 with respect to the central rear cover 2120 may be determined based on a width 2611 of the rotation limit groove 2610.

A rotation limit protrusion 2630 may be formed on the central rear cover 2120 toward the guide bracket coupling part 2320. The rotation limit protrusion 2630 may be inserted into the rotation limit groove 2610.

A maximum folding angle of the side rear cover 2110 with respect to the central rear cover 2120 may be determined by the rotation limit groove 2610 and the rotation limit protrusion 2630. When the rotation limit protrusion 2630 contacts a side wall 2612 of the rotation limit groove 2610, the side rear cover 2110 may no longer rotate with respect to the central rear cover 2120.

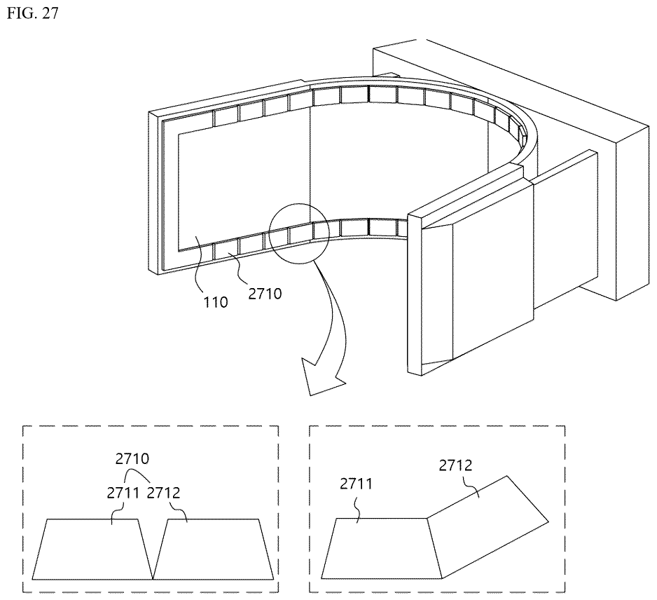

FIG. 27 is a view for explaining a radiation detector according to an embodiment of the present disclosure.

The radiation detector 100 may further comprise a plurality of bending limit parts 2710. The bending limit parts 2710 are located on a front surface of the panel assembly 110, and at least a portion thereof may protrude forward.

The plurality of bending limit parts 2710 are arranged in the first direction, and the first direction may be a direction from a left side to a right side of the radiation detector 100. The plurality of bending limit parts 2710 may be arranged along a longitudinal direction of the radiation detector 100. The plurality of bending limit parts 2710 may be arranged at regular intervals in the radiation detector 100.

When the radiation detector 100 is folded, at least a portion of the plurality of bending limit parts 2710 may contact each other to prevent the radiation detector from bending further. More specifically, the plurality of bending limit parts 2710 may comprise a first bending limit part 2711 and a second bending limit part 2712. When the radiation detector 100 is folded, a right side surface of the first bending limit part 2711 may make surface contact with a left side surface of the second bending limit part 2712, such that the radiation detector 100 may be in a state of being no longer foldable. As such, the radiation detector of the present disclosure is provided with various means for limiting the bending of the radiation detector 100, and thus may prevent various components included in the radiation detector 100 from being damaged.

The plurality of bending limit parts 2710 may have an inclined part for limiting a curvature of the radiation detector 100. However, the present disclosure is not limited thereto. The plurality of bending limit parts 2710 may not have an inclined part. Even without the inclined part, when the plurality of bending limit parts 2710 contact each other as the radiation detector 100 is folded, the bending of the radiation detector 100 may no longer be performed.

When the radiation detector is unfolded, the plurality of bending limit parts 2710 may serve to protect the panel assembly 110. Since the plurality of bending limit parts 2710 protrude forward of the panel assembly 110, when the radiation detector 100 is in close contact with the object 130, the plurality of bending limit parts 2710, not the panel assembly 110, contact the object 130, and thus the panel assembly 110 may be protected.

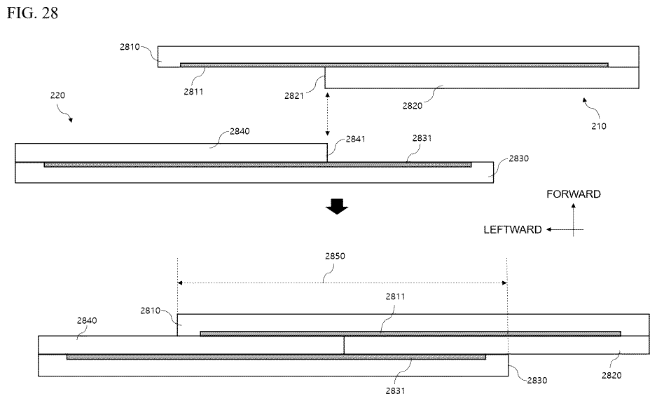

FIG. 28 is a view for explaining a radiation detector according to an embodiment of the present disclosure.

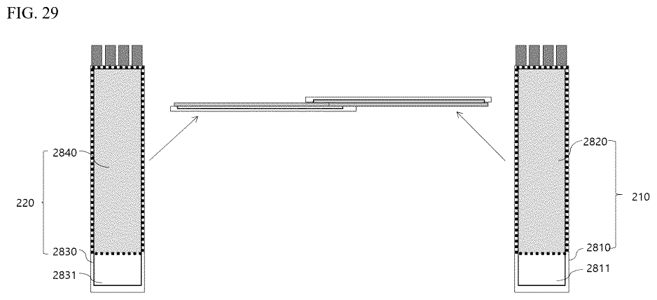

FIG. 29 is a view for explaining a radiation detector according to an embodiment of the present disclosure.

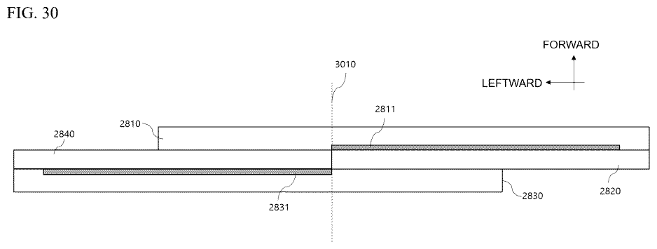

FIG. 30 is a view for explaining a radiation detector according to an embodiment of the present disclosure.

FIG. 28 to FIG. 30 may explain FIG. 2 to FIG. 9 in more detail.

Referring to FIG. 28, the first radiation detection panel 210 may comprise at least one of a first TFT panel 2810 and a first scintillator 2820.

The first radiation detection panel 210 may comprise the first TFT panel 2810. At least a portion of the first TFT panel 2810 may comprise a first active region 2811. The first active region 2811 may be a region for generating an image-related signal by receiving visible light or radiation. The first active region 2811 may comprise a plurality of photodiodes. The first active region 2811 may convert light emitted from the first scintillator 2820 into an electrical signal.

A region excluding the first active region in the first TFT panel 2810 may be an inactive region. In the inactive region, configurations for collecting a signal generated in the first active region 2811 may be located. In addition, the electrical signal collected in the inactive region may be transmitted to the first circuit unit through an ROIC.

The first scintillator 2820 may receive radiation and emit visible light. The first scintillator 2820 may comprise a fluorescent material that absorbs radiation energy and re-emits the energy as visible light. The first scintillator 2820 may comprise at least one of gadolinium oxy-sulfide (GOS) and cesium iodide (CsI). One side of the first scintillator 2820 may be located in a direction opposite to the first direction relative to one side of the first active region 2811. Here, the one side may be a left side. In addition, the first direction may be a left direction, and the direction opposite to the first direction may be a right direction.

An area of the first scintillator 2820 may be smaller than an area of the first active region 2811. Referring to FIG. 29, it may be confirmed that the area of the first scintillator 2820 is smaller than the area of the first active region 2811.

The second radiation detection panel 220 may comprise at least one of a second TFT panel 2830 and a second scintillator 2840.

The second radiation detection panel 220 may comprise the second TFT panel 2830. At least a portion of the second TFT panel 2830 may comprise a second active region 2831. The second active region 2831 may be a region for generating an image-related signal by receiving visible light or radiation. The second active region 2831 may comprise a plurality of photodiodes. The second active region 2831 may convert light emitted from the second scintillator 2840 into an electrical signal.

A region excluding the second active region in the second TFT panel 2830 may be an inactive region. In the inactive region, configurations for collecting a signal generated in the second active region 2831 may be located. In addition, the electrical signal collected in the inactive region may be transmitted to the second circuit unit through an ROIC.

The second scintillator 2840 may receive radiation and emit visible light. The second scintillator 2840 may comprise a fluorescent material that absorbs radiation energy and re-emits the energy as visible light. The second scintillator 2840 may comprise at least one of gadolinium oxy-sulfide (GOS) and cesium iodide (CsI). The other side of the second scintillator 2840 may be located in the first direction relative to the other side of the second active region 2831. Here, the other side may be a right side. In addition, the first direction may be a left direction.

An area of the second scintillator 2840 may be smaller than an area of the second active region 2831. Referring to FIG. 29, it may be confirmed that the area of the second scintillator 2840 is smaller than the area of the second active region 2831.

The first active region 2811 and the second active region 2831 may overlap, or a line connecting the one side of the first active region 2811 and the other side of the second active region 2831 may be parallel to a third direction. Here, the third direction may be a forward direction. The one side may be a left side, and the other side may be a right side.

More specifically, referring to FIG. 28, the first active region 2811 and the second active region 2831 may overlap. When viewed from a front side of the radiation detector, the first active region 2811 and the second active region 2831 may appear to overlap. An overlapping region of the first TFT panel 2810 comprising the first active region 2811 and the second TFT panel 2830 comprising the second active region 2831 may be a first adhesive region 2850. Since the first adhesive region 2850 has already been described, a detailed description thereof will be omitted.

Referring to FIG. 30, a line 3010 connecting the one side of the first active region 2811 and the other side of the second active region 2831 may be parallel to the third direction. The third direction may be a forward direction. However, the present disclosure is not limited thereto, and the third direction may be a rearward direction.

As such, when the first active region 2811 and the second active region 2831 overlap, or the line 3010 connecting the one side of the first active region 2811 and the other side of the second active region 2831 is parallel to the third direction, there are the following effects. The radiation detector 100 of the present disclosure may acquire an image of the object without lost information. More specifically, when a gap exists between the first active region 2811 and the second active region 2831 with respect to the first direction, radiation passing through the object may not reach the first active region 2811 and the second active region 2831. Here, that a gap exists between the first active region 2811 and the second active region 2831 may mean that there is no active region between the second active region 2831 located on the left side and the first active region 2811 located on the right side. The radiation detector 100 of the present disclosure may receive radiation passing through the object without omission and convert the radiation into an electrical signal due to the unique structure of the first TFT panel 2810, the first scintillator 2820, the second TFT panel 2830, and the second scintillator 2840. In addition, a contact surface is maximized because a coupling portion of the first radiation detection panel 210 and the second radiation detection panel 220 has a stepped shape, and thus the first radiation detection panel 210 and the second radiation detection panel 220 may be robustly coupled. Here, having a stepped shape means that the TFT panel and the scintillator form a stepped shape at the coupling portion. In addition, a thickness of the radiation detection panel after coupling, excluding the adhesive region, has a combined thickness of the TFT panel and the scintillator, and thus the thickness of the radiation detection panel may be thin. As such, the radiation detector of the present disclosure is robust and thin, and has an advantage of being able to image a large-diameter object.

Referring to FIG. 28, in order to create the radiation detector 100, the first radiation detection panel 210 may be coupled in a reverse direction, and the second radiation detection panel 220 may be coupled in a normal direction. Here, the reverse direction may mean that, when a radiation incident surface is a front surface, the TFT panel is located on a front side and the scintillator is located on a rear side. For example, the first TFT panel 2810 may be located in the third direction with respect to the first scintillator 2820. Here, the third direction may mean a forward direction. However, the present disclosure is not limited thereto, and the third direction may be a rearward direction. That is, the first TFT panel 2810 may be located on the front side, and the first scintillator 2820 may be located on the rear side. In addition, the normal direction may mean that, when the radiation incident surface is the front surface, the scintillator is located on the front side and the TFT panel is located on the rear side. For example, the second TFT panel 2830 may be located in a direction opposite to the third direction with respect to the second scintillator 2840. The direction opposite to the third direction may be a rearward direction. However, the present disclosure is not limited thereto, and the direction opposite to the third direction may be a forward direction. That is, the second scintillator 2840 may be located on the front side, and the second TFT panel 2830 may be located on the rear side.

As such, the first radiation detection panel 210 is coupled in the reverse direction and the second radiation detection panel 220 is coupled in the normal direction, so that a large-diameter object may be imaged while keeping the thickness of the radiation detector 100 thin. In addition, it is possible to image without a missing portion in the large-diameter object. Accordingly, the radiation detector of the present disclosure may accurately and quickly image a large-diameter object.

A contact surface is maximized because a coupling portion of the first radiation detection panel 210 and the second radiation detection panel 220 has a stepped shape, and thus the first radiation detection panel 210 and the second radiation detection panel 220 may be robustly coupled. More specifically, an end portion 2821 of one side of the first scintillator 2820 and an end portion 2841 of the other side of the second scintillator 2840 may be in contact with each other. Accordingly, in at least a portion of the first adhesive region 2850, at least one of the first scintillator 2820 and the second scintillator 2840 is located in front of the second TFT panel 2830, and the first TFT panel 2810 may be located in front of at least one of the first scintillator 2820 and the second scintillator 2840. In addition, at least a portion of a surface of the first scintillator 2820 in the direction opposite to the third direction may be in contact with at least a portion of the second active region 2831. In addition, at least a portion of a surface of the second scintillator 2840 in the third direction may be in contact with at least a portion of the first active region 2811.

The radiation detector 100 for detecting radiation may comprise: a first radiation detection panel 210, which is flexible, extending in a first direction and detecting radiation incident on a front surface; and a second radiation detection panel 220, which is flexible, extending in the first direction and detecting radiation incident on a front surface, wherein at least a portion of a rear surface of the first radiation detection panel overlaps at least a portion of a front surface of the second radiation detection panel, wherein the first radiation detection panel 210 comprises a first TFT panel 2810 comprising a first active region 2811 in at least a portion thereof. In addition, the second radiation detection panel 220 may comprise a second TFT panel 2830 comprising a second active region 2831 in at least a portion thereof.

The first active region 2811 and the second active region 2831 may overlap, or a line connecting the one side of the first active region 2811 and the other side of the second active region 2831 may be parallel to a third direction.

At this time, the first radiation detection panel 210 may comprise a first scintillator 2820 receiving radiation and emitting visible light, and one side of the first scintillator 2820 is located in a direction opposite to the first direction relative to one side of the first active region 2811. In addition, the second radiation detection panel 220 may comprise a second scintillator 2840 receiving radiation and emitting visible light, and the other side of the second scintillator 2840 is located in the first direction relative to the other side of the second active region 2831. The first TFT panel 2810 may be located in the third direction with respect to the first scintillator 2820. Here, the third direction may mean a forward direction. However, the present disclosure is not limited thereto, and the third direction may mean a rearward direction. The second TFT panel 2830 may be located in a direction opposite to the third direction with respect to the second scintillator 2840. Here, the direction opposite to the third direction may mean a rearward direction. However, the present disclosure is not limited thereto, and the direction opposite to the third direction may mean a forward direction.

In addition, at this time, the radiation detector 100 may further comprise a common scintillator located between the first radiation detection panel 210 and the second radiation detection panel 220. The common scintillator may be integrally formed. If the first scintillator 2820 and the second scintillator 2840 are included in the first radiation detection panel 210 and the second radiation detection panel 220, respectively, the common scintillator may be a scintillator shared by the first radiation detection panel 210 and the second radiation detection panel 220. The first radiation detection panel 210 may be located on at least a portion of a front surface of the common scintillator, and the second radiation detection panel 220 may be located on at least a portion of a rear surface of the common scintillator. The common scintillator may also function as an adhesive for coupling the first radiation detection panel 210 and the second radiation detection panel 220.

In FIG. 28, if the first scintillator 2820 and the second scintillator 2840 are integrally formed, it may be an implementation form using a common scintillator. The first TFT panel 2810 may be located in the third direction with respect to the common scintillator (2820 and 2840). In addition, the second TFT panel 2830 may be located in a direction opposite to the third direction with respect to the common scintillator (2820 and 2840). When implemented in this way, the possibility that the first scintillator 2820 and the second scintillator 2840 overlap is reduced, and thus manufacturing is easy, and there is an advantage that the coupled radiation detection panel may be made thin.

So far, various embodiments have been examined. Those skilled in the art to which the present invention pertains will understand that the present invention may be implemented in modified forms without departing from the essential characteristics of the present invention. Therefore, the disclosed embodiments should be considered in an illustrative point of view, not a limiting point of view. The scope of the present invention is shown in the claims rather than the foregoing description, and all differences within the equivalent scope should be interpreted as being included in the present invention.

Meanwhile, the above-described embodiments of the present invention may be written as a program executable on a computer, and may be implemented in a general-purpose digital computer that operates the program by using a computer-readable recording medium. The computer-readable recording medium includes storage media such as magnetic storage media (e.g., ROM, floppy disks, hard disks, etc.) and optical reading media (e.g., CD-ROMs, DVDs, etc.).

1. A radiation detector for detecting radiation, comprising:
a first radiation detection panel, which is flexible, extending in a first direction and detecting radiation incident on a front surface;
a second radiation detection panel, which is flexible, extending in the first direction and detecting radiation incident on a front surface, wherein at least a portion of a rear surface of the first radiation detection panel overlaps at least a portion of a front surface of the second radiation detection panel; and
a main plate, which is plate-shaped, located at rear surfaces of the first radiation detection panel and the second radiation detection panel and supporting at least a portion of the first radiation detection panel and the second radiation detection panel.

2. The radiation detector of claim 1,
wherein: at least a portion of the rear surface of the first radiation detection panel is adhered to at least a portion of the front surface of the second radiation detection panel with a first adhesive, and
at least a portion of the rear surface of the second radiation detection panel is adhered to at least a portion of the main plate with a second adhesive.

3. The radiation detector of claim 1,
wherein: at least a portion of the rear surface of the first radiation detection panel is adhered to at least a portion of the front surface of the second radiation detection panel in a first adhesive region, and
at least a portion of the rear surface of the second radiation detection panel is adhered to at least a portion of the main plate in a second adhesive region.

4. The radiation detector of claim 3,
wherein the first adhesive region and the second adhesive region are identical, and
the radiation detector further comprises a fixing bracket, which is non-bendable, fixed to a rear surface of the main plate and supporting at least a portion of the first adhesive region and the second adhesive region where the first radiation detection panel and the second radiation detection panel overlap.

5. The radiation detector of claim 3,
wherein: the first adhesive region is an overlapping region of one side of the first radiation detection panel and the other side of the second radiation detection panel, and
the second adhesive region is formed on one of the other side of the first radiation detection panel or one side of the second radiation detection panel.

6. The radiation detector of claim 1,
wherein the main plate comprises a first cable penetration hole on the other side and a second cable penetration hole on one side, and
the radiation detector further comprises:
a first circuit case coupled to a rear surface of the main plate and comprising a first circuit unit for being electrically connected to the first radiation detection panel;
a second circuit case coupled to the rear surface of the main plate and comprising a second circuit unit for being electrically connected to the second radiation detection panel;
a first flexible film passing through the first cable penetration hole and electrically connecting the first circuit case and the first radiation detection panel; and
a second flexible film passing through the second cable penetration hole and electrically connecting the second circuit case and the second radiation detection panel.

7. The radiation detector of claim 6,
wherein: at least one of the first circuit case and the second circuit case comprises a protruding coupling part extending in a direction opposite to the first direction, and
a bolt is coupled to the protruding coupling part by passing through an elongated hole extending in the first direction formed in the main plate, such that the at least one of the first circuit case and the second circuit case is fixed to the main plate.

8. The radiation detector of claim 5,
wherein: the second adhesive region is formed on the other side of the first radiation detection panel, and
one side of the rear surface of the second radiation detection panel is adhered to at least a portion of a front surface of the second circuit case in a third adhesive region.

9. The radiation detector of claim 8,
wherein an area of the first cable penetration hole is smaller than an area of the second cable penetration hole.

10. The radiation detector of claim 1,
wherein the first radiation detection panel comprises at least one of a first sub-plate or a first shielding sheet on a rear surface of the first radiation detection panel, and
the second radiation detection panel comprises at least one of a second sub-plate or a second shielding sheet on a rear surface of the second radiation detection panel.

11. The radiation detector of claim 1,
further comprising a bending support part located at a rear surface of the main plate and supporting a panel assembly comprising the first radiation detection panel, the second radiation detection panel, and the main plate,
wherein the bending support part comprises:
a first support bracket for supporting one side of the panel assembly;
a first hinge for connecting the first support bracket and a first connection bracket;
the first connection bracket coupled to the first hinge and being extendable and retractable;
a second hinge for connecting the first connection bracket and a base bracket;
the base bracket for supporting a center of the panel assembly;
a third hinge for connecting the base bracket and a second connection bracket;
the second connection bracket coupled to the third hinge and being extendable and retractable;
a fourth hinge for connecting the second connection bracket and a second support bracket; and
the second support bracket coupled to the fourth hinge and supporting the other side of the panel assembly.

12. The radiation detector of claim 1,
further comprising a bending support part located at a rear surface of the main plate and supporting a panel assembly comprising the first radiation detection panel, the second radiation detection panel, and the main plate,
wherein the bending support part comprises:
a first support bracket for supporting one side of the panel assembly;
a first connection bracket coupled to the first support bracket;
a central hinge for connecting the first connection bracket and a second connection bracket;
a base bracket located in front of the central hinge and supporting a center of the panel assembly;
the second connection bracket coupled to a second support bracket;
the second support bracket for supporting the other side of the panel assembly,
wherein the other side of a front surface of the first support bracket is formed with a first inclined part,
one side of a front surface of the second support bracket is formed with a second inclined part,
a third inclined part and a fourth inclined part are formed on the other side and the one side of a rear surface of the base bracket, respectively, and
the first inclined part, the second inclined part, the third inclined part, and the fourth inclined part determine a maximum curvature of the panel assembly.

13. The radiation detector of claim 1,
wherein:
the first radiation detection panel comprises:
a first TFT panel comprising a first active region in at least a portion of the first TFT panel; and
a first scintillator receiving radiation and emitting visible light, and one side of the first scintillator is located in a direction opposite to the first direction relative to one side of the first active region;
the second radiation detection panel comprises:
a second TFT panel comprising a second active region in at least a portion of the second TFT panel; and
a second scintillator receiving radiation and emitting visible light, and the other side of the second scintillator is located in the first direction relative to the other side of the second active region; and
the first active region and the second active region overlap, or a line connecting the one side of the first active region and the other side of the second active region is parallel to a third direction.

14. The radiation detector of claim 13,
wherein an end portion of the one side of the first scintillator and an end portion of the other side of the second scintillator are in contact with each other.

15. The radiation detector of claim 13,
wherein the first TFT panel is located in the third direction with respect to the first scintillator, and
the second TFT panel is located in a direction opposite to the third direction with respect to the second scintillator.

16. The radiation detector of claim 13,
wherein at least a portion of a surface of the first scintillator in the direction opposite to the third direction is in contact with at least a portion of the second active region, and
at least a portion of a surface of the second scintillator in the third direction is in contact with at least a portion of the first active region.

17. A radiation detector for detecting radiation, comprising:
a first radiation detection panel, which is flexible, extending in a first direction and detecting radiation incident on a front surface; and
a second radiation detection panel, which is flexible, extending in the first direction and detecting radiation incident on a front surface, wherein at least a portion of a rear surface of the first radiation detection panel overlaps at least a portion of a front surface of the second radiation detection panel,
wherein:
the first radiation detection panel comprises a first TFT panel comprising a first active region in at least a portion of the first TFT panel;
wherein the second radiation detection panel comprises a second TFT panel comprising a second active region in at least a portion of the second TFT panel; and
wherein the first active region and the second active region overlap, or a line connecting one side of the first active region and the other side of the second active region is parallel to a third direction.

18. The radiation detector of claim 17,
wherein:
the first radiation detection panel comprises a first scintillator receiving radiation and emitting visible light, and one side of the first scintillator is located in a direction opposite to the first direction relative to one side of the first active region;
the second radiation detection panel comprises a second scintillator receiving radiation and emitting visible light, and the other side of the second scintillator is located in the first direction relative to the other side of the second active region;
the first TFT panel is located in the third direction with respect to the first scintillator; and
the second TFT panel is located in a direction opposite to the third direction with respect to the second scintillator.

19. The radiation detector of claim 17,
further comprising a common scintillator located between the first radiation detection panel and the second radiation detection panel,
wherein the first TFT panel is located in the third direction with respect to the common scintillator, and
wherein the second TFT panel is located in a direction opposite to the third direction with respect to the common scintillator.
